(19) United States
(12) Patent Application Publication
(10) Pub. No.: US 2018/0063096 A1
(43) Pub. Date: Mar. 1, 2018

(54) ENCRYPTED COMMUNICATIONS

(71) Applicant: Ariel Shai ROGSON, Portland, OR (US)

(72) Inventor: Ariel Shai ROGSON, Portland, OR (US)

(21) Appl. No.: 15/244,992

(22) Filed: Aug. 23, 2016

(51) Int. Cl. H04L 29/06

(52) U.S. Cl. CPC H04L 63/0464; H04L 63/0853; H04L 63/0876

(57) ABSTRACT

A system including a sending computer system, a re-encryption server, and a receiving computer system is described. The sending computer system can encrypt a plaintext message for a recipient on the receiving computer system. The encrypted message can be sent to the re-encryption server. The re-encryption server can change the encryption on the encrypted message, producing a re-encrypted message. The re-encrypted message can be sent to the receiving computer system and decrypted for presentation to the recipient.

### FIELD

This invention relates to encrypted communications, and more particularly to encrypted communications using a common go-between.

### BACKGROUND

Communication has been a part of life for a long time, and does not require language as we understand the concept. For example, a mother knows what her baby needs when the baby cries, even though the baby cannot express in words what is needed. Language simply provided a way to organize thoughts at let people agree as to what a particular communication means.

But almost as long as there has been communication, there has been the need to keep some information secret from others. Particularly in times of war, the need for secrecy for some communications has been paramount. The so-called “Caesar Cypher”, reportedly used during the Roman Empire, was an early way to protect data. Each character in the message was shifted some number of characters (say, three) along within the alphabet. Thus, the message “Hello” would be shifted to “Khoos”. While not a difficult encryption algorithm to break, if someone did not know that the message was encoded, they might ignore it as garbage.

More recently, cryptography (the practice and study of secure communications) has become a science unto itself. Many different encryption algorithms have been developed. Some of the better known encryption algorithms include DES (the Data Encryption Standard) and AES (the Advanced Encryption Standard). In these encryption algorithms, known has private-key cryptosystems, the same encryption key is used to be encrypt and decrypt the message: the encryption key (which both the sender and the recipient of the message must know) is known as the shared secret.

Back in the 1970s, a new type of cryptosystem was developed, which used different keys to encrypt and decrypt the message. Three well-known examples of such systems are the Diffie-Hellman key exchange, the RSA encryption algorithm (named for its inventors, Ron Rivest, Adi Shamir and Leonard Adleman), and PGP (Pretty Good Privacy). Using these encryption algorithms, knowing the key used to encrypt the message does not help one to decrypt the message, as the decryption key cannot (based on current understanding) be determined from the encryption key. As a result, the key used to encrypt messages can be made public, and these encryption algorithms are known as public-key cryptosystems.

Both encryption systems have their advantages and disadvantages. DES was developed for the U.S. government, and for a long time people did not know exactly how it operated. As a result, leading experts questioned whether the algorithm was actually secure. In addition, even when originally implemented back in the 1970s, DES used a 56-bit key, which was criticized as being too short to provide adequate security. An improvement on DES, called Triple-DES, was introduced. Triple-DES used three keys, K1, K2, and K3, each of which was a 56-bit key. Encryption was achieved by alternatively encrypting and decrypting using DES with the individual keys: E_{K3} (D_{K2} (E_{K1} (plaintext))); decryption reversed this (i.e., D_{K3} (E_{K2} (D_{K1} (cyphertext)))). Because Triple-DES used three 56-bit keys, Triple-DES had the theoretical security of a 168-bit key. Later analysis showed that Triple-DES had vulnerabilities that made it no more secure than a 112-bit key (but this was still more secure than DES itself).

DES is now considered insecure. In 1999 a brute-force search (trying every possible key to locate the one used to encrypt a message) was completed in under 24 hours, demonstrating its vulnerability. Triple-DES, on the other hand, is expected to be adequately secure until around 2030.

AES, which replaced DES as the encryption standard for the U.S. government, is considered a secure algorithm, although how secure it is considered to be depends on the length of the key. For example, a 128-bit is considered sufficiently secure for material classified as SECRET by the U.S. government, but a 192-bit key or a 256-bit key is required to for material classified as TOP SECRET by the U.S. government. But it is reasonable to conclude that eventually computers will become fast enough to perform a brute-force search on even 256-bit keys.

Public-key cryptosystems operate according to different principals, typically the mathematics involving factorization of large numbers. Each party has two keys: a public key (because it is available to anyone who wants to use it) used to encrypt a message sent to the party, and a private key (known only to that party) used to decrypt messages encrypted with the public key. The problem with public key crypto-systems is that while there are no known algorithms to factor large numbers efficiently, it cannot be proven that such algorithms do not exist. This means that while public-key cryptosystems are secure today in a practical sense, they cannot be proven secure. If an efficient algorithm to factor large numbers can be developed, public key cryptosystems could be rendered practically insecure. Such a factorization algorithm might be developed tomorrow, or in 10 years, or never: it is not possible to predict. In addition, the mathematics of such algorithms makes them slower to use than private-key cryptosystems, although the speed of computers does, to some extent, negate this concern.

For use in general-use messaging, direct management of either public- or private-key cryptosystems is awkward. The sender and recipient must agree on what encryption algorithm is to be used. If the parties are using a private-key cryptosystem, they must also agree on a shared secret to be used. While not necessary complicated in principle, these issues can be problematic in practice. For example, consider a sender who communicates with two different recipients. If the parties use private-key cryptosystems, the sender must agree on a different shared secret to be used with each recipient, and must remember what key is to be used when sending a message to a particular recipient.

With public-key cryptosystems, key management is less of an issue, as there are no shared secrets that need to be protected (the sender can simply use the public key of each recipient, which are typically publicly known). But with a private-key cryptosystem, if a sender communicates with n different people, the sender needs to remember n different keys; with a private-key cryptosystem, the sender needs to remember n+1 different keys (the n public keys of the recipients, plus the sender's own private key).

Key management gets worse when a sender wants to communicate with more than one recipient in a single message. With a private-key cryptosystem, all three parties need to agree on a mutually shared secret, which can be used to encrypt a message sent between any of the three parties. Note that the parties cannot use any secret shared by only two of the parties (for example, the sender and one of the recipients), since that shared secret would permit the third party to decrypt messages meant to be kept between the two parties.

The number of keys also grows very rapidly when messages are exchanged between more than two parties. For example, consider a sender who communicates with n different other parties and might want to send a single message to any possible subset of these n parties. Using either a private- or public-key cryptosystem, in the worst case, the sender might need 2ⁿ−1 different shared secrets, to cover each possible subset of recipients. For example, if the sender communicates with only four other parties, the sender might need as many as 15 different shared secrets. (In practice, the sender would likely not need to communicate with more than a small number of such subsets. But the worst case is always a possibility.)

With public-key cryptosystems, there is also a more fundamental problem. While the parties could agree on a shared set of public and private keys in a public-key cryptosystem, using a public-key cryptosystem in such a manner defeats the purpose of the public-key cryptosystem: namely, that only the recipient of a message knows the private key that can decrypt the message. If multiple parties all know both the public and private keys, then there is no advantage to using a public-key cryptosystem over a private-key cryptosystem (and there typically is a disadvantage, since public-key cryptosystems tend to be slower than private-key cryptosystems). Therefore, public-key cryptosystems are not designed to send encrypted messages to more than one person at a time.

Another problem with encrypted communications lies in the number of different encryption algorithms and all their variations. There is no guarantee that a sender and recipient both like to use the same encryption algorithm. For example, if one party prefers DES and another prefers 256-bit AES, then for the parties to agree on how to exchange encrypted messages, one party or the other will need to install an additional encryption algorithm.

Modern encryption software addresses some of these problems, such as key management. For example, encryption software can remember every encryption key used by the sender and with which recipients each encryption key is shared. But this approach does not reduce the number of encryption keys being used; it merely takes key management out of the hands of the user. And encryption software does not address all of the problems described above.

A need remains for a way to improve how encrypted communications are handled.

### BRIEF DESCRIPTION OF THE DRAWINGS

FIG. 1 shows a system including a sender, a recipient, and a server, according to an embodiment of the invention.

FIG. 2 shows details of the computer used by the sender in FIG. 1, according to an embodiment of the invention.

FIG. 3 shows the encryption module of FIG. 2 selecting an encryption algorithm to use for the sender and recipient, according to an embodiment of the invention.

FIGS. 4A-4B show the encryption module of FIG. 2 encrypting a plaintext message, according to embodiments of the invention.

FIG. 5 shows the sender of FIG. 1 sending a single encrypted message to multiple recipients, according to an embodiment of the invention.

FIG. 6 shows a flow of information between the computer used by the sender of FIG. 1 and the server of FIG. 1 to perform encryption using a one-time pad, according to an embodiment of the invention.

FIG. 7 shows the encryption engine of FIG. 2 intercepting a request to send a message directed to an electronic mail system, according to an embodiment of the invention.

FIG. 8 shows details of the re-encryption server in FIG. 1, according to an embodiment of the invention.

FIGS. 9A-9B show how the re-encryption module of FIG. 8 can perform re-encryption of an encrypted message, according to embodiments of the invention.

FIG. 10 shows details of the association database of FIG. 8, according to an embodiment of the invention.

FIG. 11 shows details of the encryption algorithm database of FIG. 8, according to an embodiment of the invention.

FIG. 12 shows details of the security level database of FIG. 8, according to an embodiment of the invention.

FIG. 13 shows details of the computer used by the recipient in FIG. 1, according to an embodiment of the invention.

FIGS. 14A-14B show the decryption module of FIG. 13 decrypting an encrypted message, according to embodiments of the invention.

FIG. 15 shows a flow of information between the computer used by the recipient of FIG. 1 and the server of FIG. 1 to perform decryption using a one-time pad, according to an embodiment of the invention.

FIG. 16 shows a flowchart of a procedure for the computer of FIG. 2 to encrypt a message, according to an embodiment of the invention.

FIG. 17 shows a flowchart of a procedure for the computer of FIG. 2 to select an encryption algorithm, according to an embodiment of the invention.

FIG. 18 shows a flowchart of a procedure for the computer of FIG. 2 to use a one-time pad to encrypt a message, according to an embodiment of the invention.

FIG. 19 shows a flowchart of a procedure for the server of FIG. 8 to re-encrypt an encrypted message, according to an embodiment of the invention.

FIGS. 20A-20B show a flowchart of a procedure for the server of FIG. 8 to re-encrypt an encrypted message for each intended recipient, according to an embodiment of the invention.

FIG. 21 shows a flowchart of a procedure for the server of FIG. 8 to generate a one-time pad for the computer of FIG. 2 to use to encrypt a message, according to an embodiment of the invention.

FIG. 22 shows a flowchart of a procedure for the computer of FIG. 13 to decrypt an encrypted message, according to an embodiment of the invention.

FIG. 23 shows a flowchart of a procedure for the computer of FIG. 13 to use a one-time pad to decrypt an encrypted message, according to an embodiment of the invention.

### DETAILED DESCRIPTION

Reference will now be made in detail to embodiments of the invention, examples of which are illustrated in the accompanying drawings. In the following detailed description, numerous specific details are set forth to enable a thorough understanding of the invention. It should be understood, however, that persons having ordinary skill in the art may practice the invention without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the invention.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

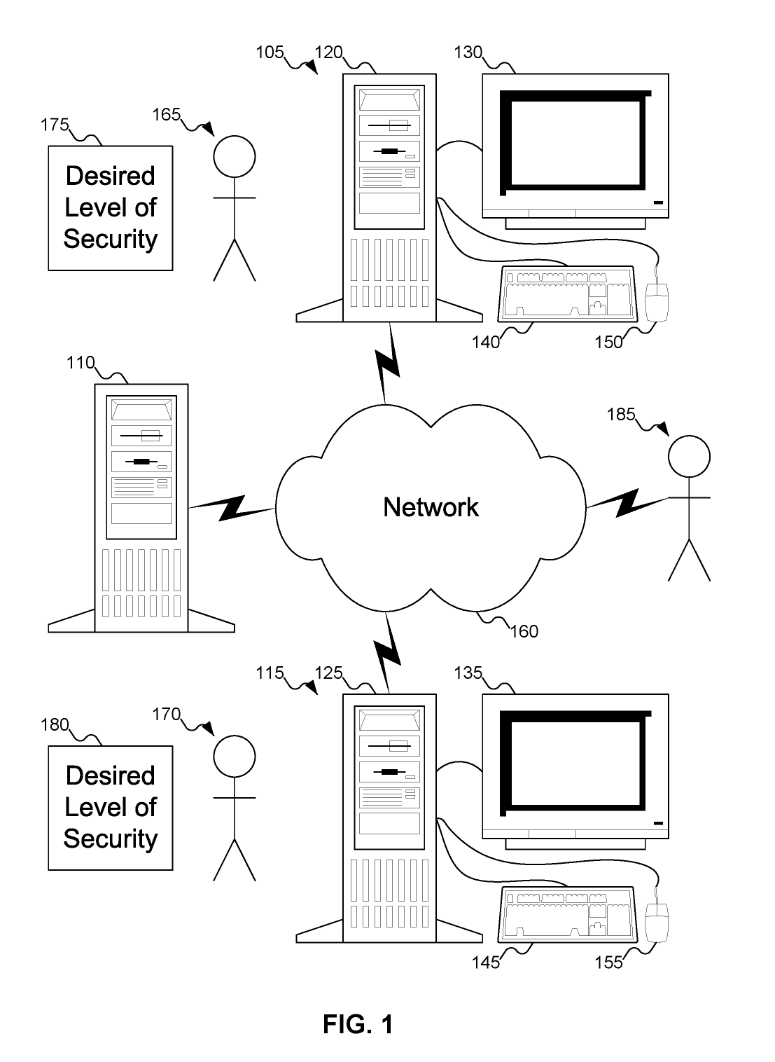

FIG. 1 shows a system including a sender, a recipient, and a server, according to an embodiment of the invention. In FIG. 1, sending computer system 105, re-encryption server 110, and receiving computer system 115 are shown. Computer systems 105 and 115 can include computers 120 and 125, monitors 130 and 135, keyboards 140 and 145, and mice 150 and 155. A person skilled in the art will recognize that other components can be included with computer systems 105 and 115: for example, other input/output devices, such as a printer, may be included. In addition, computer systems 105 and 115 can include conventional internal components not shown in FIG. 1, such as central processing units, memory, storage, etc. Computer systems 105 and 115 can also include other internal components, such as other graphics cards, modems, etc. Finally, although FIG. 1 shows computer systems 105 and 115 as conventional desktop computers, a person skilled in the art will recognize that computer systems 105 and 115 can each be any type of machine or computing device, including, for example, a laptop computer, a tablet computer, a personal digital assistant (PDA), or a smart phone, or any other device capable of sending and/or receiving data across a network, among other possibilities.

FIG. 1 shows sending computer system 105, receiving computer system 115, and re-encryption server 110 connected by network 160. Network 160 can be any type of network, including, among other possibilities, a local area network (LAN), a wide area network (WAN), and a global network (such as the Internet). In addition, network 160 can represent a hybrid design involving two or more such networks (for example, sending computer 105 can be connected to one LAN, which can be connected to the Internet which can in turn connect to re-encryption server 110 and another LAN, which can be connected to receiving computer system 115.

FIG. 1 also shows sender 165 and recipient 170. Sender 165 can be a user of sending computer 105; recipient 170 can be a user of receiving computer system 115. Note that an individual computer system can have multiple users. Therefore, sender 165 might be only one user of sending computer system 105, and recipient 170 might be only one user of receiving computer system 115. But sender 165 and recipient 170 can be representative of the users of sending computer system 105 and receiving computer system 115, respectively: the specific information might change for different users, but the principles of operation remain the same.

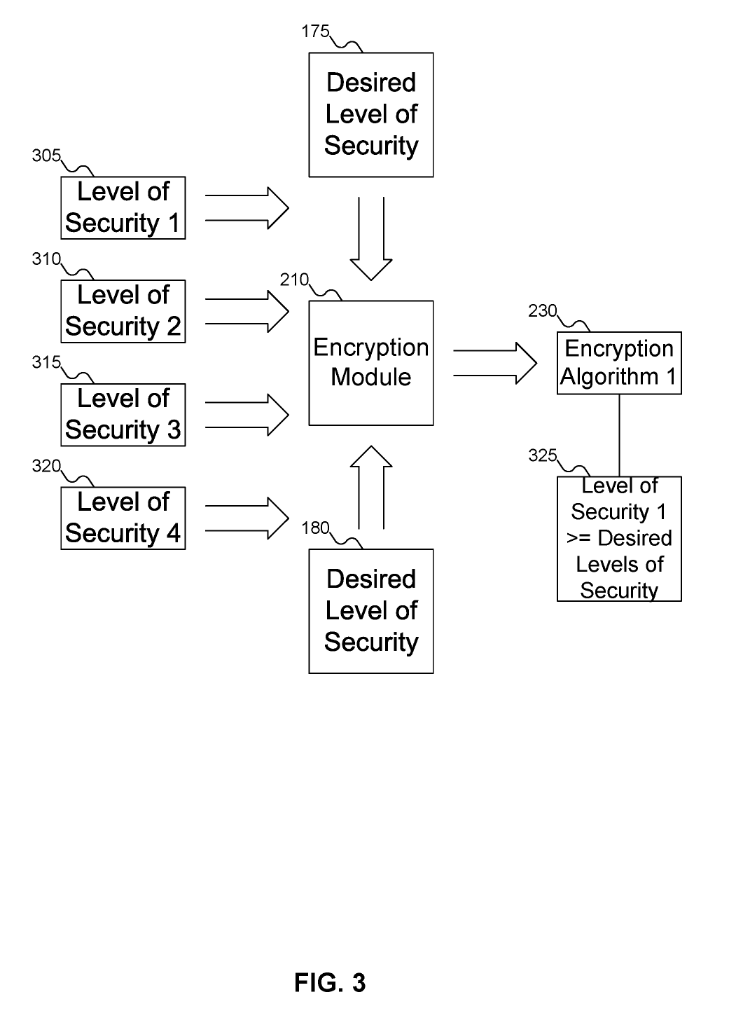

In some embodiments of the invention, each user of the computer systems can have their own desired level of security. Thus, sender 165 can have desired level of security 175, and recipient 170 can have desired level of security 180. Although desired levels of security 175 and 180 are discussed further below with reference to FIGS. 3 and 12, in brief, desired levels of security 175 and 180 can specify what level of security is desired by the corresponding user. For example, desired level of security 175 might specify that that sender 165 wants to use an encryption algorithm that is at least as secure as Triple-DES, whereas desired level of security 180 might specify that recipient 170 prefers an encryption algorithm that is as secure as 256-bit AES. While the above example desired levels of security 175 and 175 refer to specific encryption algorithms, desired levels of security 175 and 180 can describe desired levels of security 175 and 180 in other ways: for example, by referring to the effective number of bits of security provided by a preferred encryption algorithm, or by simply referring to predefined descriptor, as described below with reference to FIGS. 3 and 12.

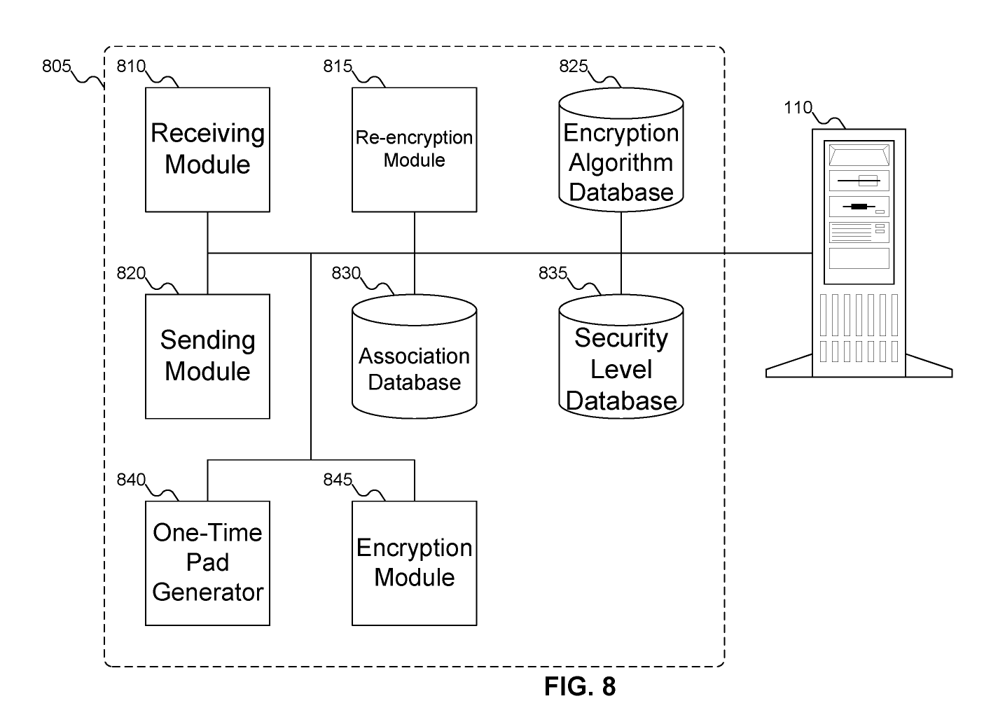

Re-encryption server 110, as described below with reference to FIGS. 8-12, is responsible for performing re-encryption on messages. In short, re-encryption server 110 can receive a message encrypted by sending computer system 105 and can replace the encryption used with a different encryption. The re-encrypted message can then be forwarded to receiving computer system 115, permitting receiving computer system 115 to decrypt the message.

FIG. 1 also shows attacker 185. Attacker 185 can be any party interested in intercepting and reading the message sent by sender 165 to recipient 170. Since attacker 185 would be able to read any messages on sending computer system 105 or receiving computer system 115 if he or she had direct access to those systems, presumably attacker 185 does not have direct access to computer systems 105 or 115, but instead can intercept a message while in transit. Thus, attacker 185 will typically be connected to network 160 in some manner. But if the message is encrypted while in transit, attacker 185 will not be able to read the message unless he or she can decrypt the message.

Embodiments of the invention have several advantages over the prior art. A first advantage of embodiments of the invention is that key management is simplified far beyond what is offered by existing encryption software. Recall that in the prior art, sender 165 needs to store one key for each recipient with which he exchanges secure messages. So if sender 165 exchanged messages with n recipients, sender 165 needed to store n different keys. In contrast, with embodiments of the invention, sender 165 only needs to store a key for each different encryption algorithm he or she uses: the number of keys stored does not depend on the number of recipients. So, for example, if sender 165 uses DES, 256-bit AES, and PGP to send encrypted messages to recipients, sending computer system 105 only needs to store three keys, even if sender 165 exchanges secure messages with 100 or more recipients. Sending computer system 105 can encrypt the message and send it to re-encryption server 110. Re-encryption server can then change the encryption of the message to an encryption algorithm preferred by the recipient, and can send the re-encrypted message to the recipient.

A second advantage of embodiments of the invention is that sender 165 and recipient 170 do not need to agree on a particular encryption algorithm. If sender 165 prefers to use 256-bit AES for encryption and recipient 170 prefers to use PGP for encryption, re-encryption server 110 can change the encryption from 256-bit AES to PGP. Thus, sender 165 and recipient 170 do not need to even agree on an encryption algorithm to use embodiments of the invention. But if sender 165 and recipient 170 use encryption algorithms with different levels of security, the message is technically only as secure as the weaker of the two encryption algorithms.

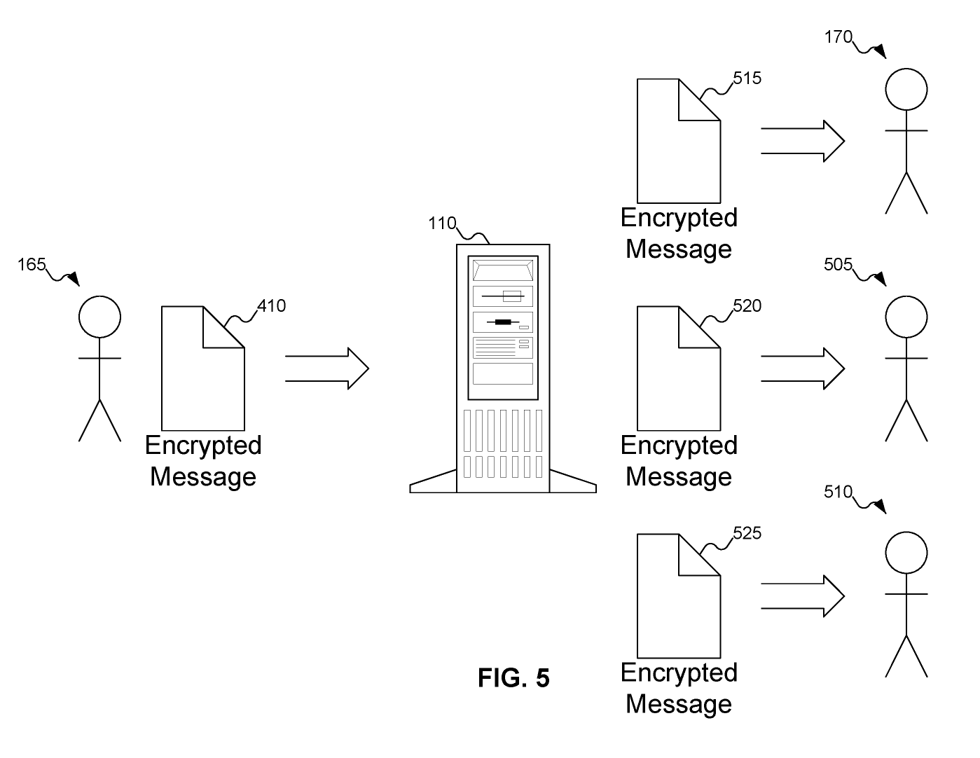

A third advantage of embodiments of the invention is support for encrypted broadcast, with sender 165 using only one encryption algorithm and one encryption key, and without the parties agreeing in advance to a particular encryption algorithm or encryption key. Sending computer system 105 can encrypt the message to be broadcast, which can then be sent to re-encryption server 110. Re-encryption server can then be responsible for encrypting the message using the preferred encryption algorithms for each of the recipients. Note that since sending computer system 105 can send a broadcast message with only one encrypted message, a public-key cryptosystem can be used to encrypt the message from sending computer system 105, enabling broadcast messaging using a public-key cryptosystem. Encrypted broadcast is described with reference to FIG. 5 below.

A fourth advantage of embodiments of the invention is that encryption can be strong enough to satisfy both sender 165 and recipient 170, again without the parties having to agree on an encryption algorithm and an encryption key in advance. Embodiments of the invention can enable sending computer system 105 to determine desired level of security 180 of recipient 170. Sending computer system 105 can then consider desired level of security 180 of recipient 170 when determining what encryption algorithm to use. For example, if sender 165 is satisfied with DES for encrypted communications but recipient 170 expects to use 256-bit AES or better, sending computer system 105 can select 256-bit AES (or a stronger encryption algorithm) when encrypting the message.

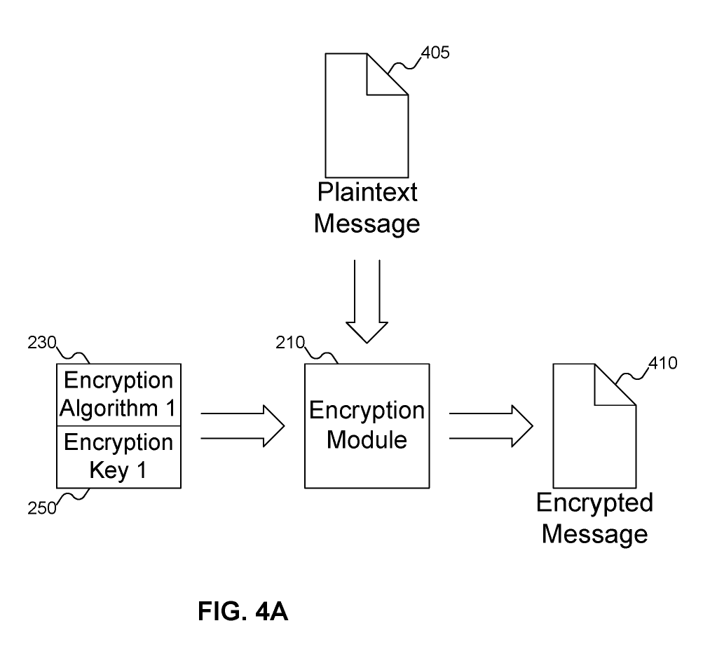

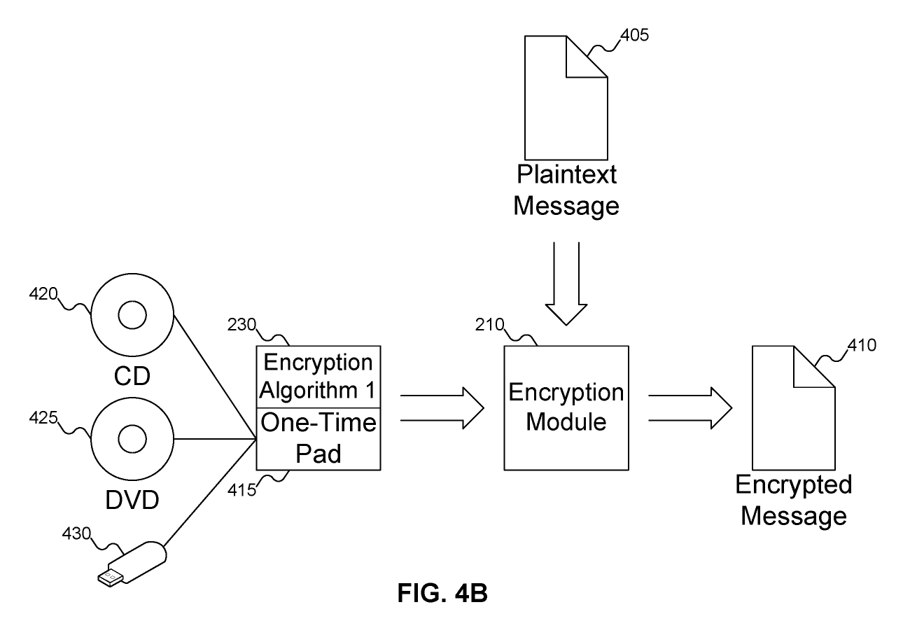

A fifth advantage of embodiments of the invention is support for one-time pads. As discussed below with reference to FIGS. 4B, 6, and 14B-15, sending computer system 105 and receiving computer system 115 can each use one-time pads to encrypt and decrypt messages. Since one-time pads provide theoretically unbreakable security (provided the one-time pad includes truly random data and is not compromised), using one-time pads can enable messaging that cannot be decrypted without a copy of the one-time pad itself.

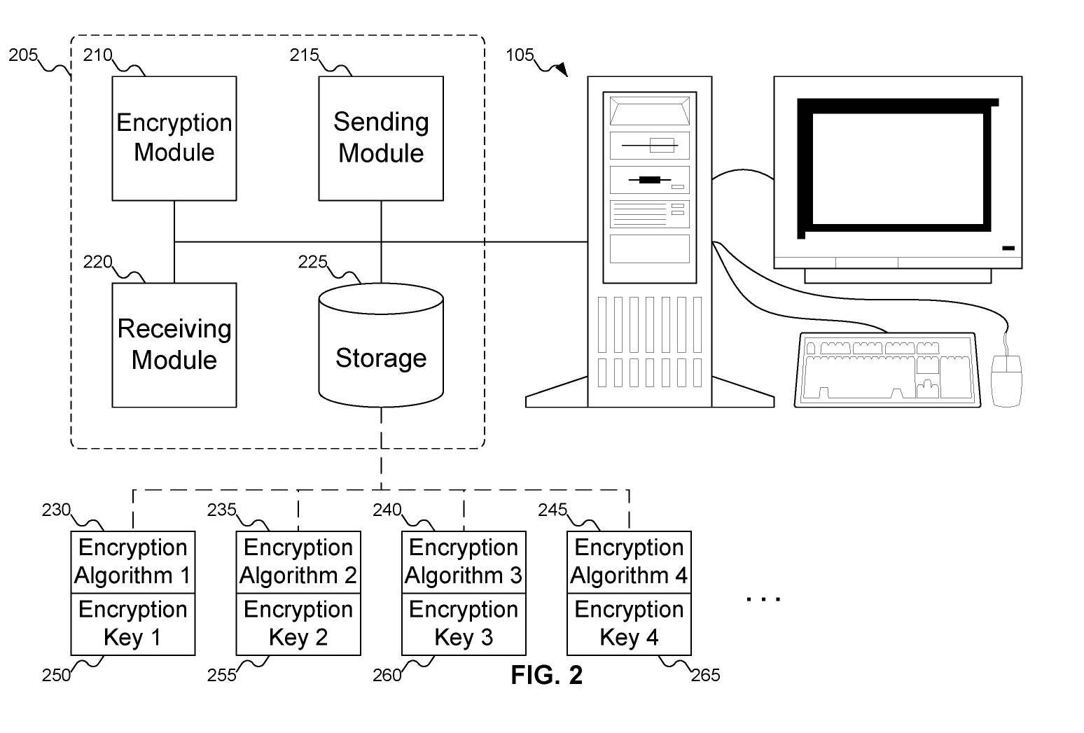

FIG. 2 shows details of the computer used by the sender in FIG. 1, according to an embodiment of the invention. In FIG. 2, computer system 105 can include encryption engine 205. Encryption engine 205 can include encryption module 210, sending module 215, receiving module 220, and storage 225.

Encryption module 210 can encrypt a message being sent from sending computer system 210. Encryption module 210 can support multiple different encryption algorithms and multiple different encryption key lengths. Encryption module 210 can support different encryption algorithms and different encryption keys in various ways. For example, in some embodiments of the invention, encryption module 210 can support pluggable modules that perform encryption using a particular algorithm and a particular key length. If support for a new encryption algorithm and/or a new encryption key length is required, a new pluggable module can be added to encryption module 210. In this manner, encryption module 210 can provide the encryption algorithms that the sender wants to use, without having to install undesired encryption algorithms. In other embodiments of the invention, encryption module 210 can include all supported encryption algorithms and encryption key lengths, and encryption module 210 can use only those encryption algorithms and encryption key lengths that the sender desires.

Sending module 215 and receiving module 220 are responsible for sending and receiving data. This data can include, for example, an encrypted message, the sender's desired level of security, the recipient's desired level of security, and updates to encryption engine 205, among other possibilities.

As an example of how sending module 215 and receiving module 220 might operate, suppose that the sender creates a message to be sent to a recipient. Sending module 215 can send the recipient's identifier to the re-encryption server, and in response receiving module 220 can receive the recipient's desired level of security. Encryption module 220 can then use this information to select the encryption algorithm to use when encrypting the message, which can then be sent to the recipient (via the re-encryption server) using sending module 215.

Storage 225 can store information in support of encryption engine 205. FIG. 2 shows storage 225 storing various encryption algorithms and encryption keys used by the sender. In FIG. 2, storage 225 is shown storing four encryption algorithms 230, 235, 240, and 245, and four encryption keys 250, 255, 260, and 265 associated with encryption algorithms 230, 235, 240, and 245, respectively. Note that encryption algorithms 230, 235, 240, and 245 do not have to be different. For example, encryption algorithms 230 and 235 might both be AES, but with encryption keys 250 and 255 being different. In addition, storage 225 can store any number of encryption algorithm and associated encryption key pairs: the four pairs shown in FIG. 2 are merely exemplary.

In addition, if storage 225 stores an encryption algorithm associated with more than one encryption key, there is no requirement that the different encryption keys used with that encryption algorithm have to be of different lengths. The different encryption keys could simply be alternative encryption keys. For example, the sender might have two different keys for a given encryption algorithm, if the sender chooses to store more than one encryption key.

One reason that a sender might have more than one encryption key to use with a given encryption algorithm is for direct encrypted messaging. For example, assume that the sender had been exchanging encrypted messages with a recipient using 256-bit AES, before using an embodiment of the invention. Once encryption engine 205 is installed, the sender can select 256-bit AES as an encryption algorithm to use, and be assigned an encryption key by the re-encryption server. (This encryption key should be different from the one the sender had previously used, since that encryption key was known to the recipient.) Storage 225 can store both the newly assigned encryption key for 256-bit AES and the encryption key that the sender and recipient had previously shared for 256-bit AES. The sender can then use encryption module 210 to encrypt a message using the older encryption key: this encrypted message can be sent directly to the recipient without having to undergo re-encryption by the re-encryption server.

FIG. 2 shows how sending computer system 210 might appear to a single user of sending computer system 210. But if sending computer system 210 is shared by multiple users, the only differences would be that storage 225 would store encryption algorithms and associated encryption keys for multiple users (thus adding a user ID to the associations), and that encryption module 210 might end up supporting more encryption algorithms/encryption key lengths than any one user of sending computer system 210 actually uses.

As described above, in some embodiments of the invention, a user can specify a desired level of security. But even though a user might have a desired level of security, the user might have one or more encryption algorithms installed on sending computer system 105 that are less secure than the user's desired level of security. This can be useful, for example, when exchanging e-mails with another user who prefers a lower level of security (although with the advantages of the re-encryption server mean that each user can have a different desired level of security, and therefore use different encryption algorithms).

FIG. 3 shows the encryption module of FIG. 2 selecting an encryption algorithm to use for the sender and recipient, according to an embodiment of the invention. In FIG. 3, encryption module 210 can receive as input sender's desired level of security 175, recipient's desired level of security 180, and levels of security 305, 310, 315, and 320, representing the levels of security offered by the encryption algorithms installed on the user's computer. Encryption module 210 can then select encryption algorithm 230 for use in encrypting a message from the sender to the recipient, based on encryption algorithm 230 have a level of security 325 that meets or exceeds desired levels of security 175 and 180 for both the sender and recipient.

It might happen that multiple encryption algorithms all meet or exceed desired levels of security 175 and 180 for the sender and recipient. In that situation, any encryption algorithm that meets or exceeds desired levels of security 175 and 180 can be chosen. For example, encryption algorithm 230 might be the encryption algorithm with the lowest level of security that meets or exceeds desired levels of security 175 and 180. Or encryption algorithm 230 might offer the highest level of security of all encryption algorithms used by the sender. Other techniques can also be used to select an encryption algorithm.

While FIG. 3 shows encryption module 210 receiving both the sender's desired level of security 175 and the recipient's desired level of security 180, in embodiments of the invention encryption module 210 would not receive the recipient's desired level of security 180. In such embodiments of the invention, encryption module 210 would be selecting an encryption algorithm bases solely on the sender's desired level of security 175.

How might it occur that the sending computer system would have an encryption algorithm that does not satisfy the sender's desired level of security 175? The sender's desired level of security 175 likely changes only infrequently, but it can change. For example, the sender might initially be satisfied with DES for encryption. Then, later, the sender might decide that 256-bit AES is his preferred level of security. In this situation, encryption module 210 can still have DES installed, even though DES would not satisfy the sender's updated desired level of security 175. After all, the sender might change desired level of security 175, and be satisfied with DES once again. (This shows that encryption module 210 does not need to remove older encryption algorithms, although encryption module 210 can eliminate encryption algorithms that do not satisfy the sender's desired level of security.)

Desired levels of security 175 and 180 can be represented in a number of ways. For example, the encryption algorithms can be ordered in lowest-to-highest level of security order, such as DES, Triple-DES, RSA, PGP, 128-bit AES, 192-bit AES, 256-bit AES, and one-time pad. Desired levels of security 175 and 180 can then name a particular encryption algorithm, and that encryption algorithm (and any higher security encryption algorithm) will satisfy desired levels of security 175 and 180.

Alternatively, encryption algorithms can be sorted into categories that are considered to be roughly comparable in security. For example, category 1 might include DES and Triple-DES, category 2 might include RSA and PGP, category 3 might include 128-bit AES, category 4 might include 192-bit AES and 256-bit AES, and category 5 might include one-time pad. Then desired levels of security 175 and 180 simply identify the target category: any encryption algorithm sorted into that or a higher category would be considered to meet or exceed desired levels of security 175 and 180.

While FIG. 3 shows one way in which to select an encryption algorithm to encrypt the plaintext message, in other embodiments of the invention the sender can select which encryption algorithm (and encryption key) are to be used to encrypt the plaintext message. Yet other embodiments of the invention can combine both approaches: encryption module 210 can select an encryption algorithm as shown in FIG. 3 by default, but accepts the sender overriding this approach by requesting a particular encryption algorithm to be used. And yet other embodiments of the invention can operate in reverse: encryption module 210 can assume that the sender will select the encryption algorithm (and encryption key) to use, but will select the encryption algorithm as shown in FIG. 3 if the sender instructs encryption module 210 to select the encryption algorithm.

FIGS. 4A-4B show the encryption module of FIG. 2 encrypting a plaintext message, according to embodiments of the invention. In FIG. 4A, encryption module 225 can receive plaintext message 405 and encryption algorithm 230 and associated encryption key 250. Encryption algorithm 230 and associated encryption key 250 can be selected as described above with reference to FIG. 3. Encryption module 225 can then use encryption algorithm 230 with encryption key 250 to encrypt plaintext message 405 into encrypted message 410.

In FIG. 4A (and in FIG. 4B below), plaintext message 405 is intended to encompass all possible forms that a message might take. For example, a message might be just ordinary unformatted text. But a message could including formatting, or images (such as images stored in the Joint Photographic Experts Group (JPEG) format or Graphics Interchange Format (GIF) format), or video files, or files not intended to be changed (such as the Adobe Portable Document Format (PDF)® file format), or any combination of these, among other possibilities. (Adobe PDF is either a registered trademark or a trademark of Adobe Systems Incorporated in the United States and/or other countries.)

FIG. 4B is similar to FIG. 4A. But in FIG. 4B, encryption can be performed using one-time pad 415. A one-time pad is a list of truly random data (where there is no pattern that can be used to determine one character given any other characters in the one-time pad). The characters in the one-time pad can be drawn from any desired alphabet. Thus, the characters on one one-time pad might use Arabic numbers and Roman letters, whereas another one-time pad might use bits (0s and 1s): the particular one-time pad used would depend on the application. Each character in the one-time pad can be combined with a character in the message to be encrypted: for example, by using modulo arithmetic, provided the process can be reversed for decryption (this combining operation can be performed by encryption algorithm 230).

Using a one-time pad is the only theoretically provably secure way to protect data, assuming that the characters in the one-time pad are truly random and the one-time pad is not compromised in some way. Since there is no relationship between how one character is encrypted and how another character is encrypted, there is no way to determine what the one-time pad is or how the encryption was performed. For example, the message “Hello” could be encrypted using a particular one-time pad to produce “Qkrtb”. But using a different one-time pad, the message “Later” could result in the same encryption. Since there is no way to know which one-time pad was used, there is no way to recover the original message without knowing the exact one-time pad used.

One-time pads are theoretically perfectly secure, but they have their own costs. First, as noted above, to achieve the theoretical perfect security the data in the one-time pad must be truly random. If the data is only pseudorandom, as can result from a random character generator on a computer, the characters in the one-time pad might have a pattern that could be recognized, enabling decryption of the original message. A second problem with one-time pads is that the one-time pad needs to be delivered in a manner that prevents interception. If a one-time pad were sent over a network, an attacker might be able to intercept the one-time pad and could then decrypt any messages encrypted using that one-time pad. A third problem with one-time pads is that one-time pads, as their name implies, should only be used once. If data on a one-time pad is used more than once to encrypt data, a careful analysis of the encrypted messages could permit an attacker to recover the one-time pad (and therefore any messages encrypted using the one-time pad).

A fourth problem with one-time pads is that a one-time pad must be at least as long the message being encrypted, since repeated use of characters in the one-time pad could permit an attacker to decrypt the message. For example, assume that a sender wanted to send a text document that was 10,000 characters long using a one-time pad. The sender would then need a one-time pad that included 10,000 characters. This is a lot of data for a one-time pad that is used only once. And one-time pads are not just for textual data: anything could be encrypted using a one-time pad, even images. If the sender wants to send an image file that is 5 MB in size, the sender would need a one-time pad that was 5 MB in size. Managing this amount of information in one-time pads can be very cumbersome.

One solution to managing the size of one-time pads would be to use some publicly-available text. For example, a sender might select a book, pick a random starting point in that book (counting characters from the beginning of the book), and start drawing characters sequentially from that book, treating the text like a one-time pad. This has the advantage that the sender and receiver (be it a person or the re-encryption server) do not need to agree in advance on a one-time pad: the sender can just provide the receiver with International Standard Book Number (ISBN) of the selected book, and the starting character number. But note that this approach is not as secure as traditional one-time pad. The text of the book is not random, meaning that the encrypted text can be subject to a linguistic analysis (for example, if an attacker is certain that the book is in the English language and is certain that a particular character from the book was the letter “q”, then the attacker can be virtually certain that the next letter from the book was “u”). In addition, if the identity of the book and the starting point are not protected, the attacker can easily identify the source of the encryption key, making decryption a trivial process.

Security of this book one-time pad approach can be improved by selecting a book that would not be subject to the same linguistic analysis as the plaintext. For example, if the plaintext message is in English, the selected book could be in Sanskrit. Since the languages are different, the linguistic analyses are different. The “book” could also be a document of some other form than written language, such as an image, among other possibilities. But while this compounds the analyses the attacker must perform, security is not enhanced that much. And the identity of the selected book and the starting point for character selection still must be carefully protected.

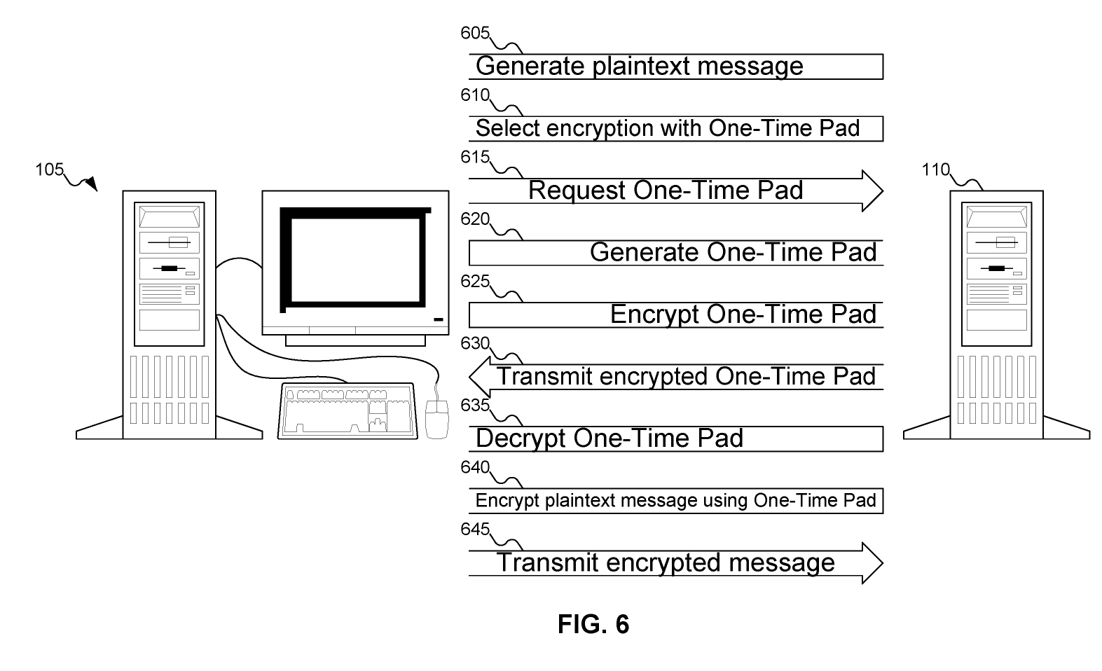

One-time pad 415 can be accessed from a number of different sources, including Compact Disc (CD) 420, Digital Video Disc (DVD) 425, or Universal Serial Bus (USB) key 430 (sometimes called a thumb drive). These devices can be considered secondary storage (in the sense that sources such as CD 420, DVD 425, and USB key 430 are secondary to the primary storage of the sending computer system). One-time pad 415 can also be accessed from the primary storage of the sending computer system, although the expectation is that one-time pad 415 will be replaced on a fairly regular basis. Another possibility for the source of one-time pad 415 is described below with reference to FIG. 6.

FIG. 5 shows the sender of FIG. 1 broadcasting a single encrypted message to multiple recipients, according to an embodiment of the invention. In FIG. 5, sender 165 can send encrypted message 410 to recipients 170, 505, and 510. Using traditional encryption, sender 165 would need to either generate a separate encrypted message 410 for each recipient, or sender 165 and recipients 170, 505, and 510 would need to agree in advance on a single shared secret among the four parties. But with embodiments of the invention, sender 165 can generate one encrypted message 410 without having to agree in advance on a shared secret with recipients 170, 505, and 510. Instead, sender 165 generates encrypted message 410, which can be sent to re-encryption server 110. Re-encryption server 110 can then generate re-encrypted messages 515, 520, and 525 for each of recipients 170, 505, and 510, respectively. While FIG. 5 shows sender 165 sending a broadcast message to three recipients, embodiments of the invention can include a broadcast message destined for any number of recipients, each of which can receive the broadcast message using a private encryption method.

FIG. 6 shows a flow of information between the computer used by the sender of FIG. 1 and the server of FIG. 1 to perform encryption using a one-time pad, according to an embodiment of the invention. As described above, one-time pads require that the parties agree and exchange the one-time pad in advance. FIG. 6 shows how one-time pads can be used by a sender in a more spontaneous manner.

In FIG. 6, at operation 605, the sender can generate the plaintext message. At operation 610, sending computer system 105 can select to perform encryption using a one-time pad. As described above with reference to FIGS. 1 and 3, the selection of a one-time pad for encryption could be because the sender wants to use a one-time pad for encryption, or because the recipient wants to use a one-time pad. At operation 615, sending computer system 105 can request that re-encryption server 110 generate a one-time pad. At operation 620, re-encryption server 110 can generate the one-time pad.

Using one-time pads in the traditional manner, re-encryption server 110 would have to arrange delivery of the one-time pad to sending computer system 105 in some secure manner, such as by courier delivery. But such a delivery mechanism would be time-consuming (delaying delivery of the sender's message), expensive (particularly to rush the courier), or both. As an alternative, re-encryption server 110 can deliver the one-time pad to sending computer system 105 electronically. While this approach does reduce the security associated with the one-time pad, as will be described below the security should still be ample.

At operation 625, re-encryption server can encrypt the one-time pad. The one-time page can be encrypted using any desired encryption algorithm (that the sender can decrypt): typically, the selected encryption algorithm can be one that is preferred by the sender or meets the sender's desired level of security. Note that there is little value in encrypting a one-time pad with another one-time pad; therefore, the encryption algorithm used to encrypt the one-time pad will usually be lower than the level of security offered by a one-time pad. At operation 630, re-encryption server 110 can transmit the encrypted one-time pad to sending computer system 105. At operation 635, sending computer system 105 can decrypt the one-time pad. At operation 640, sending computer system 105 can use the one-time pad to encrypt the plaintext message. And at operation 645, sending computer system 105 can transmit the encrypted message to re-encryption server 110.

As mentioned above, sending an encrypted one-time pad over a network can reduce the security of the one-time pad. But this reduced security can be considered an acceptable risk. Assume first that the one-time pad is generated from truly random data. Then there is no pattern that can be found to help determine any character in the one-time pad given other characters in the one-time pad. Nor is this assumption unreasonable: re-encryption server 110 can store truly random data en masse specifically to produce one-time pads as needed. For example, atmospheric radio noise can be used to produce near infinite quantities of truly random data by mapping various frequencies to 0s and 1s. If character data is needed instead of binary data, series of such bits can be concatenated to form random characters using a desired character set, such as the American Standard Code for Information Interchange (ASCII), Unicode, or other character sets.

Given the assumption that the one-time pad consists of truly random data, there is no pattern that can be derived by analysis of the one-time pad. That is, given any number of characters from the one-time pad, it is not possible to determine any other particular character in the one-time pad. This means that the one-time pad cannot be subject to any linguistic analysis. But if the one-time pad cannot be subject to linguistic analysis, an encrypted one-time pad cannot be subject to linguistic analysis either. Therefore, the best an attacker can do is to exploit a weakness in the encryption algorithm, if one exists. For example, if the encryption algorithm used to encrypt the one-time pad has a backdoor, the attacker can use that backdoor to decrypt the one-time pad. But without a weakness in the encryption algorithm, the best an attacker can do is to brute-force the one-time pad: that is, to try every possible encryption key to recover the one-time pad.

But as the one-time pad consists of truly random data, even after brute-forcing the encryption on the one-time pad, the attacker still does not know the original one-time pad: all the possible decryptions of the one-time pad will look equally random. Thus, the attacker must not only try every possible encryption key on the encrypted one-time pad, the attacker must also then try the result of that decryption on the original message. While this extra step does not add much delay to the attacker's efforts, it avoids the attacker immediately knowing when he has recovered the original one-time pad.

Some numbers might help to elucidate this discussion. Assume that the one-time pad includes 1000 characters (that is, the sender wants to encrypt a plaintext message that included 1000 characters using a one-time pad): a very short message. Further assume that the character set includes 256 characters (ASCII is a character set that includes 256 bits; in comparison, Unicode includes 16,536 characters). That means that there are 256¹⁰⁰⁰≈1.7×10²⁴⁰⁸ possible one-time pads. Even assuming an attacker could try one quadrillion (10¹²) different one-time pads per second, it would take an attacker approximately 5.5×10²³⁸⁸ years: far older than the age of the universe (which is estimated to be approximately 1.377×10¹³ years old). And since any encrypted message can be produced from any plaintext message using some one-time pad, the attacker still has no way to know what the original message was.

But assume that re-encryption server 110 encrypted the one-time pad using 256-bit AES. The attacker then knows that there are 2²⁵⁶ possible keys used to encrypt the one-time pad. There is no way to know which key was used by looking at the results of the decryption: the attacker will then have to try each decrypted one-time pad on the encrypted message. On average the attacker will need to try 2²⁵⁵≈1.2×10⁷⁷ different keys before he successfully decrypts the original message. Again assuming the attacker can try 10¹² one-time pads each second, the attacker will need approximately 3.6×10⁵⁷ years to recover the original message: far less time than would be required to try every possible one-time pad, but still longer than the age of the universe.

Even assuming computers increase in speed, it will be a long time before a brute-force attack of this type will become feasible. And it will be even longer before a feasible brute-force attack will return a timely message (timeliness would depend on the message: some messages might be considered timely if decrypted a week or more being sent, whereas others would not be timely even a few minutes later). And increasing the length of the encryption key will further delay the attacker: if the encryption key were 1024 bits long, it would take the attacker approximately 5.7×10²⁸⁸ years to recover the original message.

Note that while the length of the message can affect how many one-time pads an attacker might have to try (even assuming it was worthwhile, since every possible plaintext message can produce every possible encrypted message using some one-time pad), this result is not true when the one-time pad is encrypted using some other encryption algorithm. When a one-time pad is encrypted, the one-time pad effectively becomes a message, and the encryption key used to encrypt the one-time pad establishes the limit of security.

One potential weakness to encrypting a one-time pad is that if an attacker takes the time to brute-force the one-time pad to recover the plaintext message, the attacker then has the encryption key used for the encryption algorithm applied to the one-time pad. The attacker could then quickly recover any subsequent one-time pads encrypted using that encryption algorithm and encryption key. A way to mitigate this concern is to change to a new encryption key after the encryption key is used to encrypt the one-time pad. In that manner, an attacker would not be able to leverage one brute-force search for an encryption key against other encrypted messages. But note that this concern is no greater than when that encryption algorithm is used to encrypt any other message. If an attacker wanted to recover the user's encryption key for that encryption algorithm, the attacker could brute-force any message encrypted using that encryption algorithm and encryption key: there is nothing special about the message being a one-time pad.

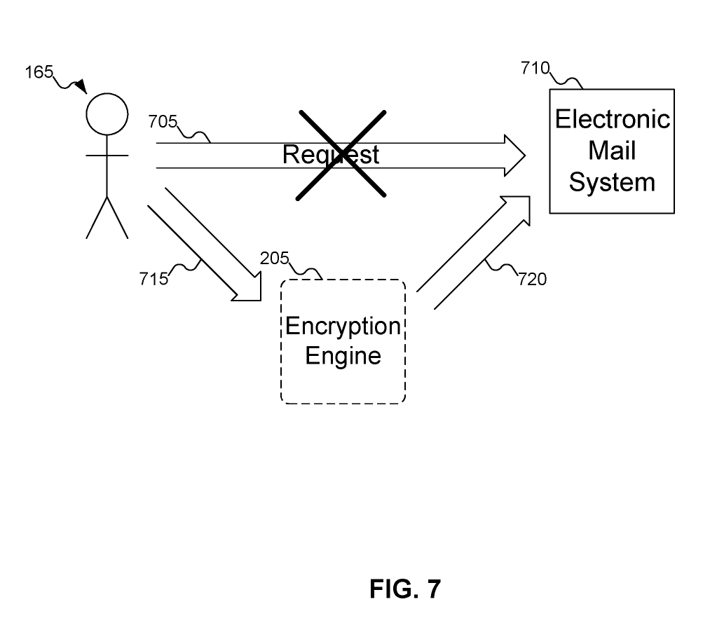

FIG. 7 shows the encryption engine of FIG. 2 intercepting a request to send a message directed to an electronic mail system, according to an embodiment of the invention. In FIG. 7, sender 165 has generated a plaintext message, and sent request 705 to electronic mail system 710 to send the message to a recipient. Encryption engine 205 can intercept request 705, and instead redirect the plaintext message through encryption engine 205 as shown by arrow 715. For example, encryption engine can include a plug-in that replaces how electronic mail system 710 normally processes a “send message” command with instructions to encrypt the message and re-directing the message to the re-encryption server. Encryption engine 205 can then convert the plaintext message to an encrypted message, and can then send the encrypted message to electronic mail system 710, as shown by arrow 720. In this manner, encryption engine 205 can perform encryption when sender 165 performs what amounts to a normal “send” command to electronic mail system 710, avoiding the need for sender 165 to explicitly request encryption of the plaintext message.

FIG. 8 shows details of the re-encryption server in FIG. 1, according to an embodiment of the invention. In FIG. 8, re-encryption server 110 can include re-encryption engine 805, responsible for changing the encryption on a message. Re-encryption engine 805 can include receiving module 810, re-encryption module 815, sending module 820, encryption algorithm database 825, association database 830, security level database 835, one-time pad generator 840, and encryption module 845. Receiving module 810 and sending module 820 can be used to receive information and send information, respectively. For example, receiving module 810 can receive an encrypted message from a sender, and sending module 820 can send a re-encrypted message to a recipient.

Re-encryption module 815 can perform re-encryption of a message: that is, re-encryption module can decrypt an encrypted message using a sender's encryption algorithm and encryption key, and re-encrypt the decrypted message using a recipient's encryption algorithm and encryption key (in either order). Encryption algorithm database 825 can store information about encryption algorithms used by the system. Security level database 835 can store information about the various security levels offered by the system, and which encryption algorithms satisfy which security levels. Association database 830 can store information about which encryption algorithms are used by various users of the system, and the encryption keys used by those users.

One-time pad generator 840 can generate a one-time pad for use by a user of the system. Encryption module 845 can be used to encrypt the one-time pad generated by one-time pad generator 845, for transmission to the requesting user. Although FIG. 8 shows encryption module 845 as a separate component, encryption module 845 performs a function that is also performed by re-encryption module 815: a single module can perform encryption in both uses.

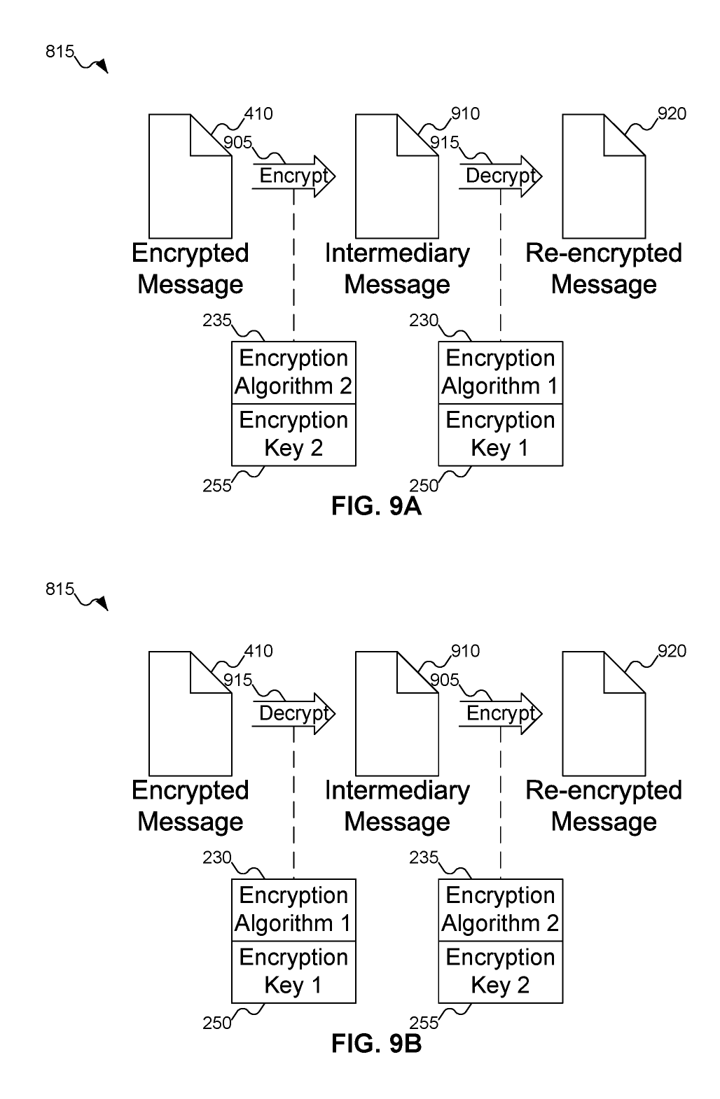

FIGS. 9A-9B show how the re-encryption module of FIG. 8 can perform re-encryption of an encrypted message, according to embodiments of the invention. In FIG. 9A, re-encryption is performed by first performing a second encryption, then by performing a decryption. Specifically, encrypted message 410 can be encrypted, in encryption operation 905, using second encryption algorithm 235 and second encryption key 255, both associated with the recipient of the message. The result of encryption operation 905 is intermediary message 910. Intermediary message 910 can then be decrypted, in decryption operation 915, using first encryption algorithm 230 and first encryption key 250, both associated with the sender of the message. The result of decryption operation 915 is re-encrypted message 920.

Note that performing re-encryption by encrypting first, as shown in FIG. 9A, keeps the contents of the message secure, since the message does not exist in plaintext on the re-encryption server. But performing re-encryption as shown in FIG. 9A depends on the order of encryption operation 905 and decryption operation 915 being commutative: that is, re-encrypted message 920 should be the same regardless of whether encryption operation 905 is performed first or decryption operation 915 is performed first. If the order of encryption operation 905 and decryption operation 915 affects the result (re-encrypted message 920), then performing re-encryption as shown in FIG. 9A is contra-indicated.

In FIG. 9B, in contrast, decryption operation 915 is performed first. Thus, encrypted message 410 can be first decrypted in decryption operation 915, using first encryption algorithm 230 and first encryption key 250, both associated with the sender of the message. The result of decryption operation 915 is intermediary message 910. Intermediary message 910 can then be encrypted, in encryption operation 905, using second encryption algorithm 235 and second encryption key 255, both associated with the recipient of the message. The result of encryption operation 905 is re-encrypted message 920.

Then process of re-encryption, as shown in FIG. 9B, will always work to re-encrypt the message. But intermediary message 910 will temporarily store the plaintext of the message. Intermediary message 910 resides on the re-encryption server for only a brief period of time, though minimizing the likelihood that the plaintext of the message can be intercepted.

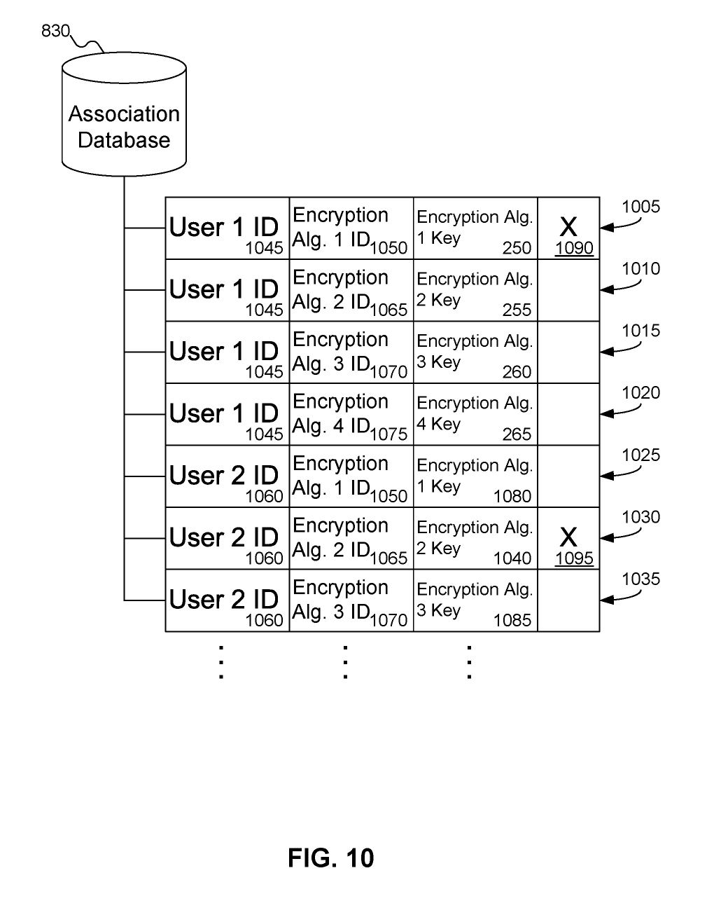

FIG. 10 shows details of the association database of FIG. 8, according to an embodiment of the invention. In FIG. 10, association database 830 can include associations 1005, 1010, 1015, 1020, 1025, 1030, and 1035, but association database 830 can store any number of associations. Each association identifies a user, an encryption algorithm, and an encryption key for that encryption algorithm used by that user. For example, association 1040 associates user ID 1045 (which can be, for example, sender 165 of FIG. 1) as using encryption key 250 when using the encryption algorithm with encryption algorithm ID 1050 (which can, for example, identify encryption algorithm 230 of FIG. 2).

Associations 1005, 1010, 1015, and 1020 all identify the user with user ID 1045, which can be, for example, sender 165 of FIG. 1; associations 1025, 1030, and 1055 all identify the user with user ID 1060, which can be, for example, recipient 170 of FIG. 1. Associations 1005 and 1025 both identify the encryption algorithm with ID 1050; associations 1010 and 1030 both identify the encryption algorithm with ID 1065; associations 1015 and 1035 both identify the encryption algorithm with ID 1070; association 1020 identifies the encryption algorithm with ID 1075. Note that the same encryption algorithm can be included in multiple associations. Thus, for example, the encryption algorithm identified by encryption algorithm ID 1050 is shown as included in both association 1005 (with user ID 1045) and association 1025 (with user ID 1060).

Typically, the various encryption keys will differ, both from user to user and from encryption algorithm to encryption algorithm. Thus, encryption keys 250, 255, 260, 265, 1080, 1040, and 1085 are likely all different. But it is possible for a user to use the same encryption key with multiple encryption algorithms (if those encryption algorithms all accept that key), and even for different users to use the same encryption key.

While FIG. 10 does not show two associations including both the same user and encryption algorithm ID, it is possible for there to be multiple associations with the same user ID and encryption algorithm ID. This can occur, for example, if different versions of an encryption algorithm can support different encryption key lengths, but the encryption algorithm versions are all identified using the same encryption algorithm ID. Typically, however, different versions of an encryption algorithm will have different IDs, to avoid the possibility of confusion as to which encryption key was used to encrypt a message.

In some embodiments of the invention, association database 830 can also identify which combination of encryption algorithm and encryption key is preferred by the various users. Thus, preference indicator 1090 indicates that user 1 (ID 1045) prefers to use encryption algorithm 1 (ID 1050) and encryption key 250, whereas preference indicator 1095 user 2 (ID 1060) prefers to use encryption algorithm 2 (ID 1065) and encryption key 1040.

The re-encryption server can use association database 830 to access the various encryption keys used by the users when performing re-encryption (as described above with reference to FIGS. 9A-9B). Thus, knowing the ID of the sender and the ID of the encryption algorithm used to encrypt the message, the re-encryption server can access the appropriate encryption key from one of the associations in database 830. Similarly, knowing the ID of the recipient and the ID of the recipient's preferred encryption algorithm (or the ID of an encryption algorithm that satisfies the security level of both sender and recipient), the re-encryption server can access the appropriate key from one of the associations in database 830.

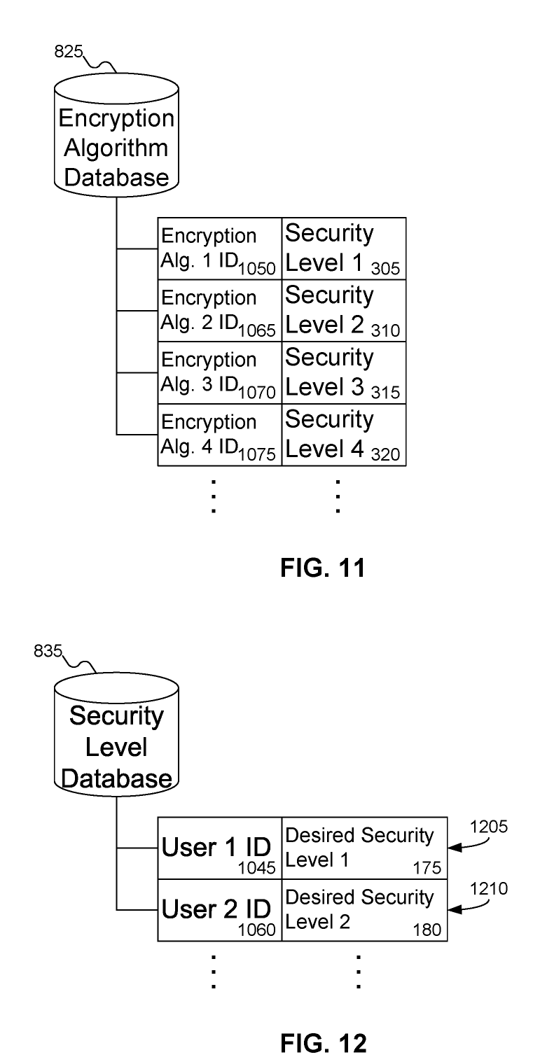

FIG. 11 shows details of the encryption algorithm database of FIG. 8, according to an embodiment of the invention. In FIG. 11, encryption algorithm database 825 can include various pairings. Each pairing indicates the security level for the corresponding encryption algorithm. Thus, for example, the encryption algorithm with ID 1050 has security level 305, the encryption algorithm with ID 1065 has security level 310, the encryption algorithm with ID 1070 has security level 315, and the encryption algorithm with ID 1075 has security level 320.

As described above, security levels 305, 310, 315, and 320 can be represented in any desired manner. For example, security levels 305, 310, 315, and 320 can be numbers such as “1”, “2”, “3”, and “4”, where “1” represents the highest level of security and “4” represents the lowest level of security (or vice versa). Or, security levels 305, 310, 315, and 320 can be the effective number of bits of security offered by the various encryption algorithms (for example, “1 bit” for a Caesar shift cypher, “56 bits” for DES, “112 bits” for Triple-DES, and so on. Other ways to represent security levels 305, 310, 315, and 320 can also be used.

While FIG. 11 shows a different security level for each encryption algorithm, different encryption algorithms can be mapped to the same security level. In fact, it is relatively unlikely that each encryption algorithm will be mapped to a different security level. More likely, in some embodiments of the invention, there will be multiple encryption algorithms that map to at least one common security level.

In FIG. 10, association database 830 can include preference indicators 1090 and 1095, which can identify users' preferred encryption algorithms. But rather than identifying a particular encryption algorithm, a user can specify a desired security level. Using the combination of information in the association database and the encryption algorithm database, the re-encryption server can select an encryption algorithm that satisfies the user's desired level of security without being encouraged to use a specific encryption algorithm. FIG. 12 shows how the re-encryption server can store information about the users' desired security levels.

FIG. 12 shows details of the security level database of FIG. 8, according to an embodiment of the invention. In FIG. 12, security level database 835 can store pairings 1205 and 1210. Pairings 1205 and 1210 can include identifiers 1045 and 1045 for users 1 and 2, respectively, and their corresponding desired security levels 175 and 180, respectively. In this manner, the re-encryption server can identify an encryption algorithm that satisfies a user's desired level of security without having to specify a particular encryption algorithm.

Security level database 835 can also be used when a sender's computer encrypts a message. As described above, when sender's computer can request from the re-encryption server the recipient's desired level of security. The re-encryption server can access this information from security level database 835 and provide the recipient's desired level of security to the sender's computer. In this manner, the sender's computer can select an encryption algorithm that satisfies both the sender's and recipient's desired levels of security.

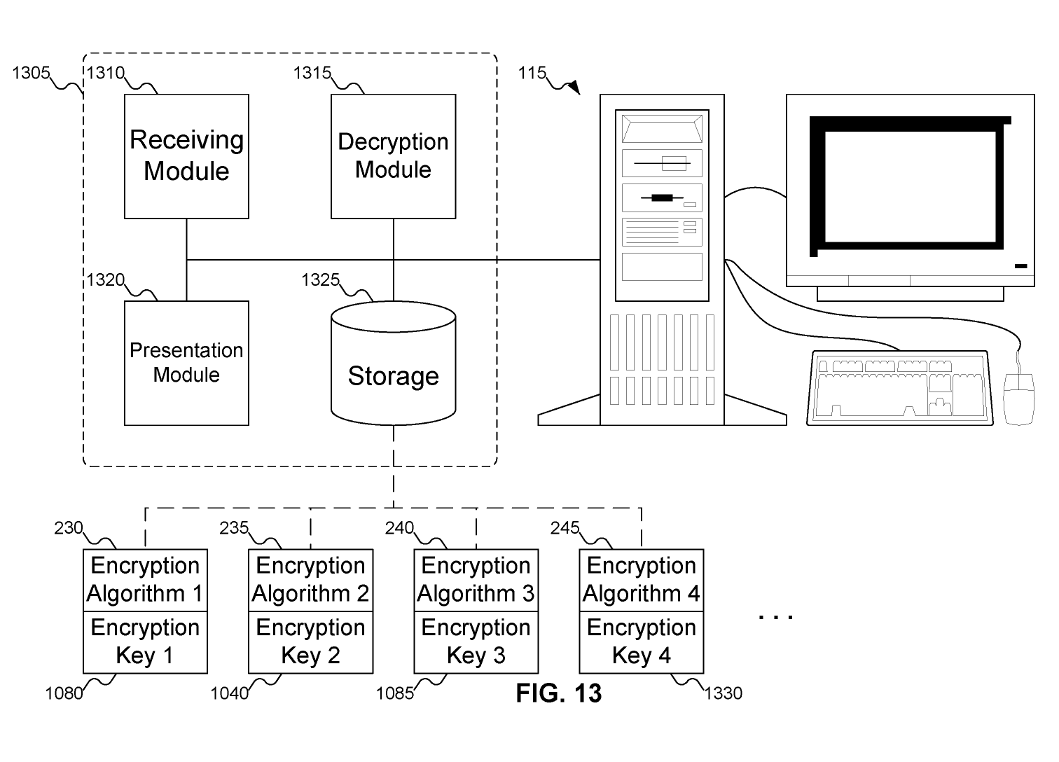

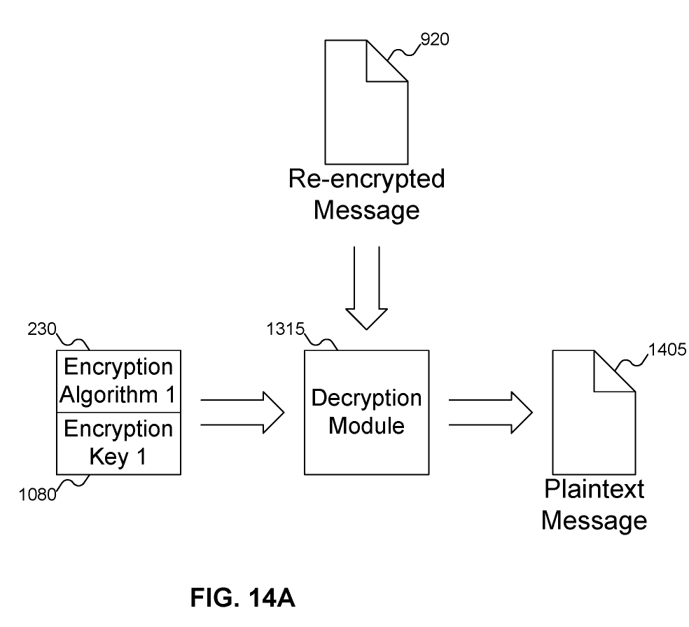

FIG. 13 shows details of the computer used by the recipient in FIG. 1, according to an embodiment of the invention. In FIG. 13, receiving computer system 115 can include decryption engine 1305. Decryption engine 1305 can include receiving module 1310, decryption module 1315, presentation module 1320, and storage 1325. Receiving module 1310 can receive data (such as encrypted messages) from the re-encryption server. Decryption module 1315 can decrypt encrypted messages. Presentation module 1320 can present a decrypted message to the recipient: for example, by displaying the decrypted message on the screen of the recipient's computer. Storage 1325 can store information about encryption algorithms and encryption keys used by the recipient. Note that while storage 1325 can store encryption algorithms 230, 235, 240, and 245—the same encryption algorithms as used by the sender's computer—storage 1325 can store encryption keys 1080, 1040, 1085, and 1330, which are the particular encryption keys used by the recipient's computer in conjunction with encryption and decryption. Note that while FIG. 13 shows storage 1325 as storing four encryption algorithms and four encryption keys, storage 1325 can store any number of encryption algorithms and encryption keys.

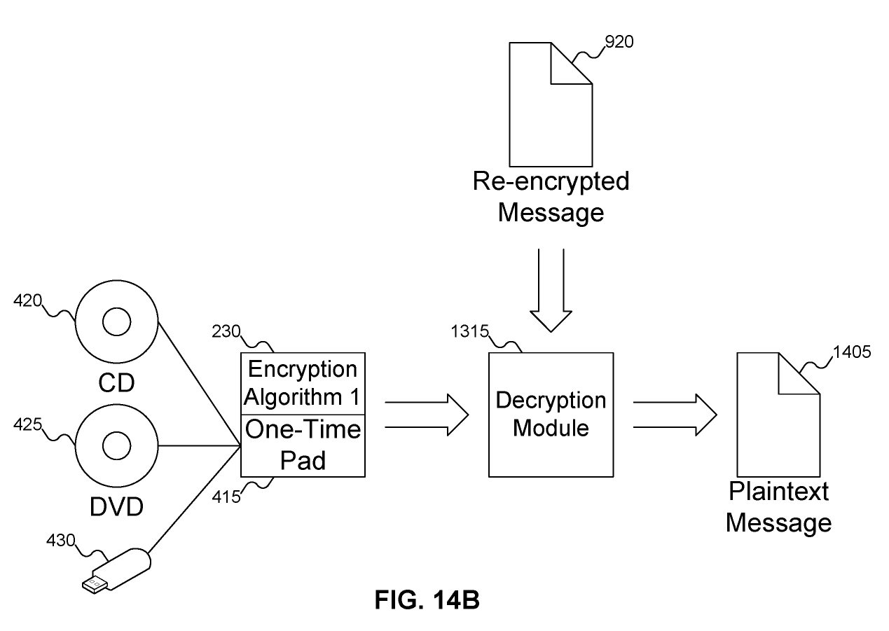

FIGS. 14A-14B show the decryption module of FIG. 13 decrypting an encrypted message, according to embodiments of the invention. In FIG. 14A, decryption module 1315 can receive re-encrypted message 920 and encryption algorithm 230 and associated encryption key 1080. Which encryption algorithm was used to encrypt re-encrypted message 920 can be embedded within (or sent along with) re-encrypted message 920, to enable the recipient's computer to select the appropriate encryption algorithm to use for decryption. Decryption module 1315 can then use encryption algorithm 230 with encryption key 1080 to decrypt re-encrypted message 920 into plaintext message 1405, which can be presented to the user.

In FIG. 14A (and in FIG. 14B below), plaintext message 1405 is intended to encompass all possible forms that a message might take. For example, a message might be just ordinary unformatted text. But a message could including formatting, or images (such as images stored in the JPEG format or GIF format), or video files, or files not intended to be changed (such as the Adobe PDF file format), or any combination of these, among other possibilities.

FIG. 14B is similar to FIG. 14A. But in FIG. 14B, decryption can be performed using one-time pad 415. As described above with reference to FIG. 4B, a one-time pad is a list of truly random data (where there is no pattern that can be used to determine one character given any other characters in the one-time pad). The characters in the one-time pad can be drawn from any desired alphabet. Thus, the characters on one one-time pad might use Arabic numbers and Roman letters, whereas another one-time pad might use bits (0s and 1s): the particular one-time pad used would depend on the application. Each character in the one-time pad can be combined with a character in re-encrypted message 920 to be decrypted: for example, by using modulo arithmetic (this combining operation can be performed by encryption algorithm 230).

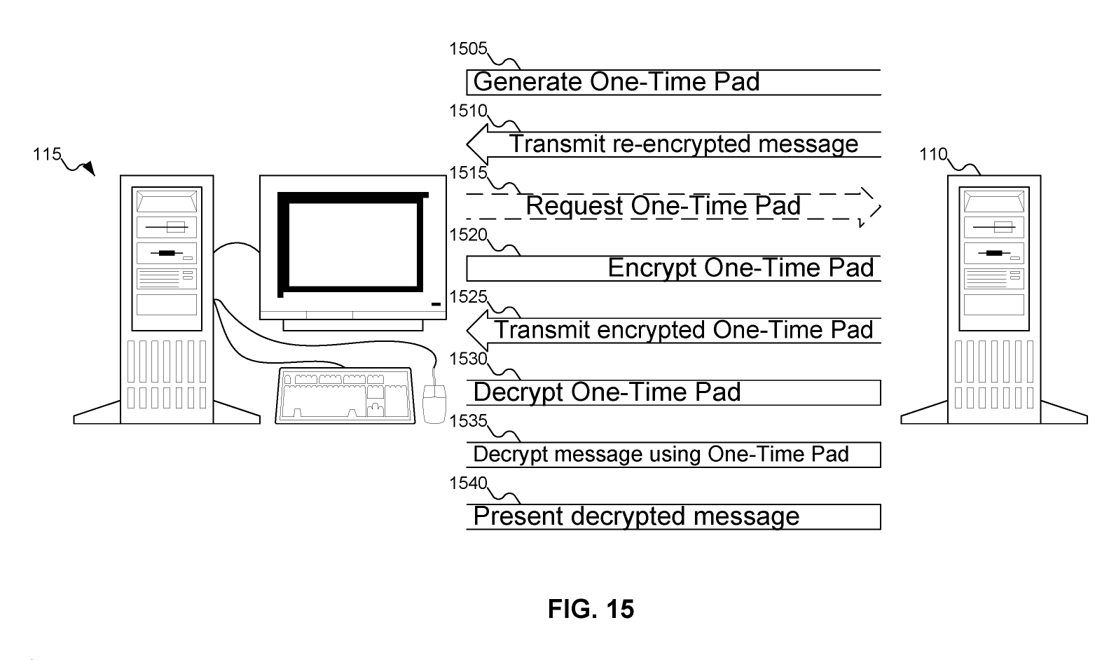

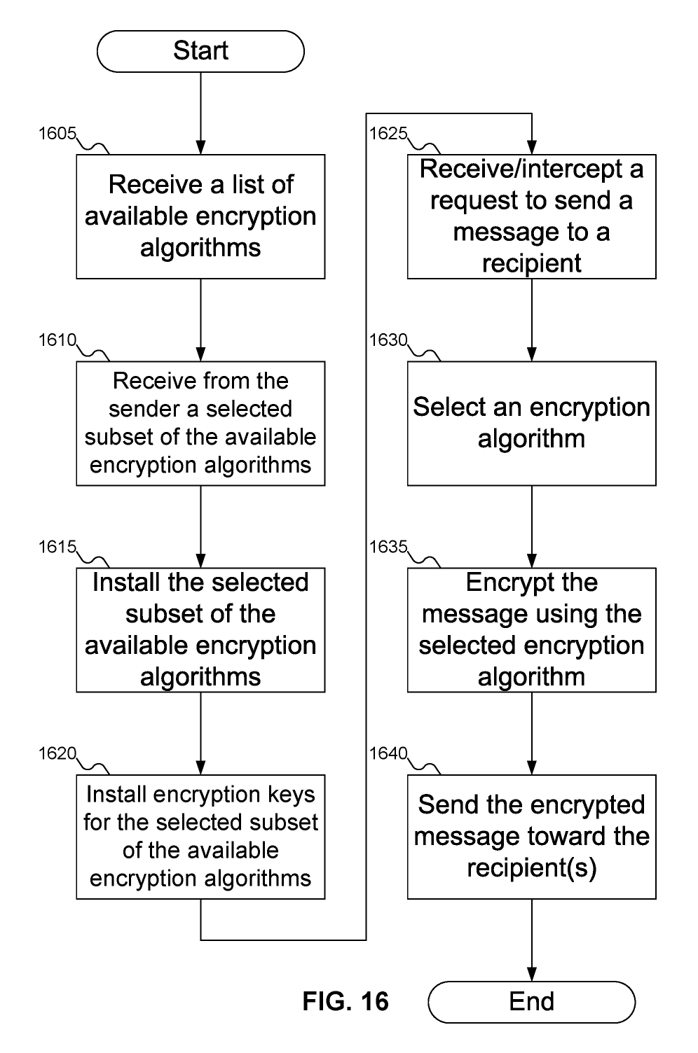

One-time pad 415 can be accessed from a number of different sources, including CD 420, DVD 425, or USB key 430. Note that CD 420, DVD 425, and USB key 430, while using the same reference numbers as those of FIG. 4B, are intended to represent different physical media than those used inn FIG. 4B. Put another way, each user can use his own secondary storage: users do not have to share secondary storage devices. Another possibility for the source of one-time pad 415 is described below with reference to FIG. 15.

FIG. 15 shows a flow of information between the computer used by the recipient of FIG. 1 and the server of FIG. 1 to perform decryption using a one-time pad, according to an embodiment of the invention. As described above, one-time pads require that the parties agree and exchange the one-time pad in advance. FIG. 15 shows how one-time pads can be used by a recipient in a more spontaneous manner.

In FIG. 15, at operation 1505, re-encryption server 110 can generate the one-time pad, which can then be used to re-encrypt the message. As described above with reference to FIGS. 1 and 3, the selection of a one-time pad for encryption could be because the sender wants to use a one-time pad for encryption, or because the recipient wants to use a one-time pad. At operation 1510, re-encryption server 110 can transmit the re-encrypted message to receiving computer system 115.

At operation 1515, receiving computer system 115 can request the one-time pad from re-encryption server 110. At operation 1520, re-encryption server 110 can encrypt the one-time pad for transmission to receiving computer system 115. The one-time page can be encrypted using any desired encryption algorithm (that the recipient can decrypt): typically, the selected encryption algorithm can be one that is preferred by the recipient or meets the recipient's desired level of security. Note that there is little value in encrypting a one-time pad with another one-time pad; therefore, the encryption algorithm used to encrypt the one-time pad will usually be lower than the level of security offered by a one-time pad. At operation 1525, re-encryption server 110 can send the encrypted one-time pad to receiving computer system 115. At operation 1530, receiving computer system 115 can decrypt the one-time pad. At operation 1535, receiving computer system 115 can use the one-time pad to decrypt the re-encrypted message, and at operation 1540, receiving computer system 115 can present the decrypted message to the recipient.

Note that there is no relationship, or lack thereof, between the encryption algorithm and encryption key used to re-encrypt the re-encrypted message and the encryption algorithm and encryption key used to encrypt the one-time pad. Thus, the one-time pad can be encrypted using the same encryption algorithm or a different encryption algorithm than the re-encrypted message, and the one-time pad can be encrypted using the same encryption key or a different encryption key than that used to encrypt the re-encrypted message. Two specific cases that are entirely possible are to use a public key cryptosystem to encrypt the one-time pad but a private key cryptosystem to encrypt the message (using the one-time pad), or to use two different encryption algorithms, but with the same encryption key, to encrypt the one-time pad and the re-encrypted message.

Note that operation 1515 is not required as it is implied: if the recipient prefers to use a one-time pad and does not currently store the one-time pad on a secondary storage (or other storage), the recipient will need to have the one-time pad transmitted to him to decrypt the message. Thus, operation 1515 is shown with dashed lines. In addition, if re-encryption server 110 uses a one-time pad of which the recipient does not have a copy, re-encryption server 110 can automatically perform operations 1520 and 1525. Finally, re-encryption server 110 can transmit the encrypted one-time pad contemporaneously with the encrypted message. That is, re-encryption server 110 can transmit the encrypted one-time pad to receiving computer system 115 around the same time that re-encryption server 110 transmits the re-encrypted message. Re-encryption server 110 can also transmit the encrypted one-time pad in the same communication with or in a different communication from the communication with the re-encrypted message.

While FIGS. 2-7 and 13-15 describe the sending computer system as including an encryption engine and the receiving computer system as including a decryption engine, in practice both the sending computer system and the receiving computer system can each include both the encryption engine and the decryption engine. After all, in practice a particular user can act as both a sender and a recipient, depending on the e-mail. Thus, while the drawings show the encryption engine and the decryption engine being on different computers, in practice both engines are typically installed on both machines.

FIG. 16 shows a flowchart of a procedure for the computer of FIG. 2 to encrypt a message, according to an embodiment of the invention. In FIG. 16, at block 1605, the sending computer system can receive a list of available encryption algorithms. At block 1610, the sender can select which encryption algorithms to install on the sending computer system. At block 1615, the selected encryption algorithms can be installed on the sending computer system. At block 1620, encryption keys for the sender can be installed on the sending computer system. These encryption keys can be generated either on the sending computer system or on the re-encryption server, and then securely shared with the other machine.

At block 1625, the sending computer system receives a request to send an encrypted message to a recipient. Block 1625 can be performed by the sending computer system intercepting a request to send a message and automatically applying an encryption algorithm to the message. At block 1630, an encryption algorithm can be selected. In some embodiments of the invention, the sender can select the encryption algorithm. In other embodiments of the invention, the sending computer system can select the encryption algorithm based on information provided by the sender (and possibly the recipient, if both desired levels of security are used).

At block 1635, the sending computer system can encrypt the message using the selected encryption algorithm. The sending computer system can use the sender's encryption algorithm that corresponds to the selected encryption algorithm to encrypt the message. Finally, at block 1640, the sending computer system can transmit the encrypted message to the re-encryption server.

Although FIG. 16 shows blocks 1605-1640 as a single flowchart, not all blocks are necessarily performed at the same time. For example, blocks 1605-1620 can be performed when the encryption system is first installed on the sending computer system (or first configured for a new user of the sending computer system), and blocks 1625-1640 can be performed at a later time, when the sender wants to send a message using the encryption system.

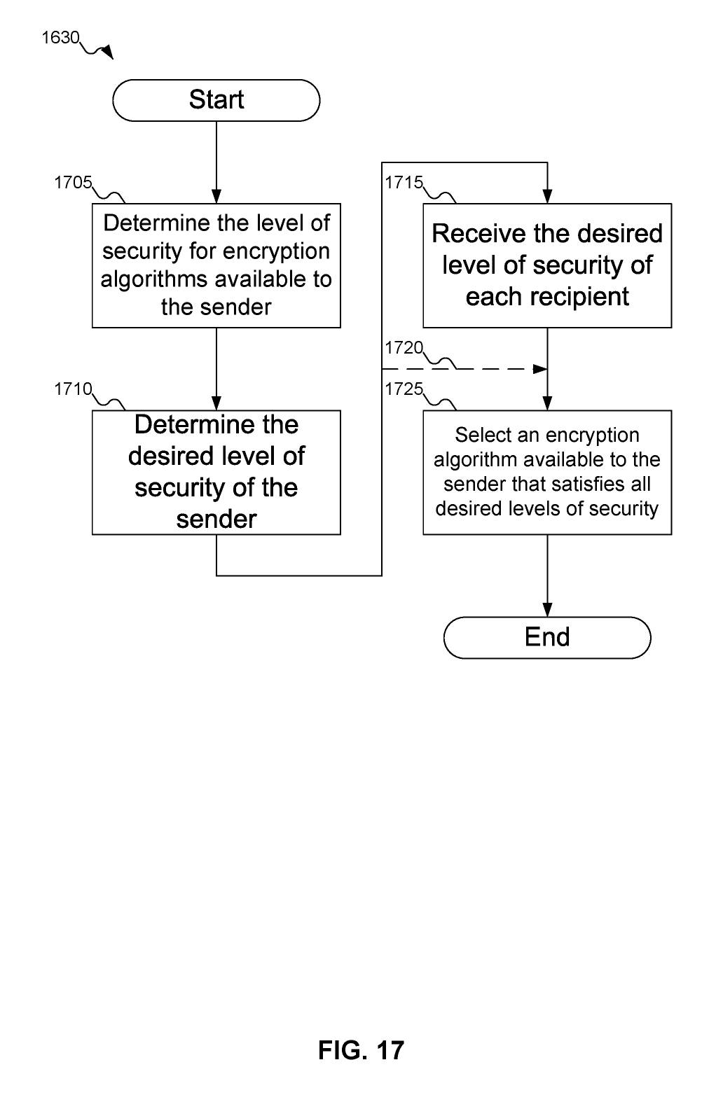

FIG. 17 shows a flowchart of a procedure for the computer of FIG. 2 to select an encryption algorithm, according to an embodiment of the invention. In FIG. 17, at block 1705 the sending computer system can determine the security levels of the encryption algorithms installed on the sending computer system. At block 1710, the sending computer system can determine the sender's desired level of security. At block 1715, the sending computer system can determine the recipient's desired level of security. As shown by dashed line 1720, block 1715 can be omitted, in which case only the sender's desired level of security would be considered in selecting an encryption algorithm. At block 1725, the sending computer system can select an encryption algorithm that satisfies all the considered desired levels of security.

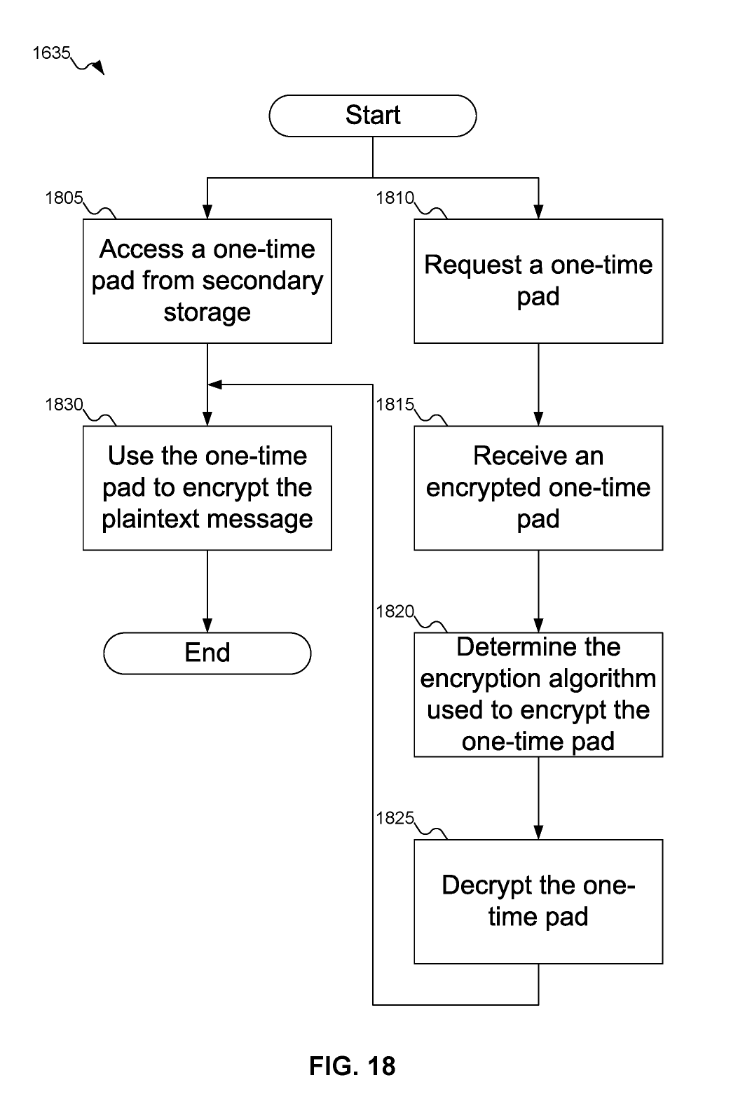

FIG. 18 shows a flowchart of a procedure for the computer of FIG. 2 to use a one-time pad to encrypt a message, according to an embodiment of the invention. In FIG. 18, at block 1805, the sending computer system can access a one-time pad from storage (either secondary storage or primary storage). Alternatively, at block 1810, the sending computer system can request a one-time pad from the re-encryption server. Then, at block 1815, the sending computer system can receive an encrypted one-time pad from the re-encryption server. At block 1820, the sending computer system can determine the encryption algorithm used to encrypt the one-time pad (for example, the sender's preferred encryption algorithm, if one is known, or an encryption algorithm that is at least as secure as the sender's desired level of security). At block 1825, the sending computer system can access the encryption key used by the sending computer system with the determined encryption algorithm and decrypt the one-time pad.

Either way, whether a one-time pad is accessed from storage or received encrypted from the re-encryption server, at block 1830 the sending computer system can use the one-time pad to encrypt the plaintext message.

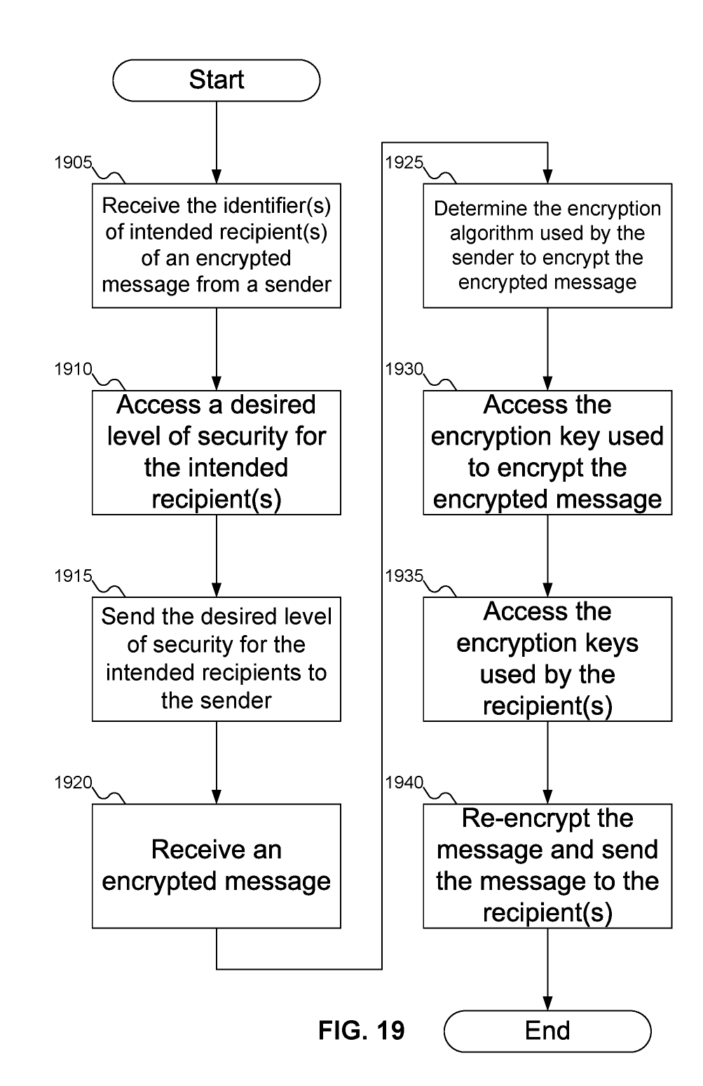

FIG. 19 shows a flowchart of a procedure for the server of FIG. 8 to re-encrypt an encrypted message, according to an embodiment of the invention. At block 1905, the re-encryption server can receive from the sending computer system identifiers of the intended recipients of an encrypted message. At block 1910, the re-encryption server can access the desired levels of security for all the intended recipients. At block 1915, the re-encryption server can send the accessed desired levels of security to the sending computer system (to enable the sending computer system to attempt to select an encryption algorithm that will satisfy the security requirements of all participants).

At block 1920, the re-encryption server can receive an encrypted message from the sending computer system. At block 1925, the re-encryption server can determine the encryption algorithm used by the sending computer system to encrypt the message. As described above, an identifier of the encryption algorithm used to encrypt a message can be attached or sent in parallel to the encrypted message. At block 1930, the re-encryption server can access the encryption key used by the sending computer system to encrypt the message (to enable the re-encryption system to decrypt the message). Note that if the sending computer system used a public key cryptosystem to encrypt the message, then the re-encryption server would access the key needed to decrypt the message, which would be different from the key used to encrypt the message. At block 1935, the re-encryption server can access the encryption keys to be used to encrypt copies of the message to the various recipients. Finally, at block 1940, the re-encryption server can re-encrypt the message for each recipient and can send the re-encrypted messages to the recipients.

Although FIG. 19 shows blocks 1905-1940 as a single flowchart, not all blocks are necessarily performed at the same time. For example, blocks 1905-1915 can be performed when the re-encryption server receives a request for the desired levels of security of the message's intended recipients, and blocks 1920-1940 can be performed at a later time, when the re-encryption server receives the encrypted message from the sending computer system. In addition, blocks 1905-1915 can be omitted if the sending computer system selects an encryption algorithm based solely on the sender's desired level of security. In such a situation, processing would begin with block 1920.

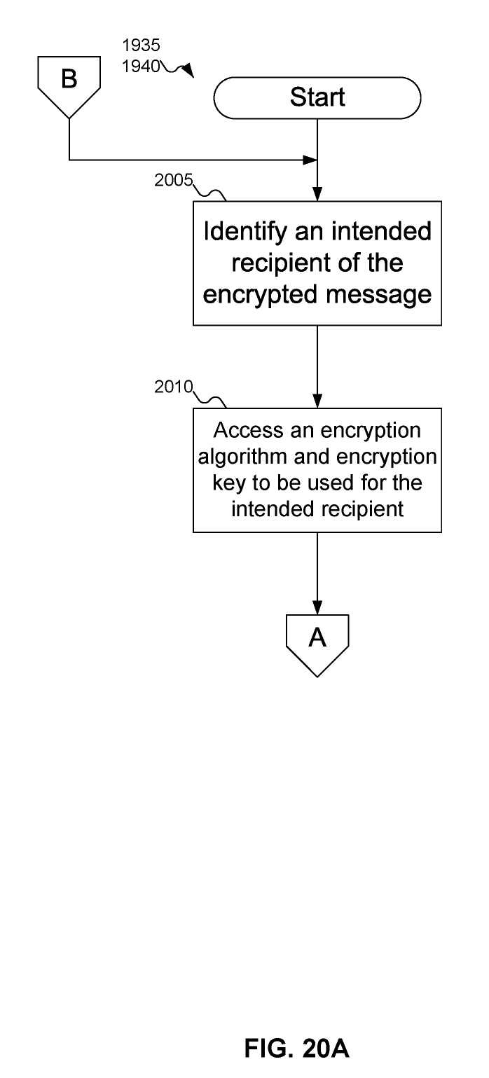

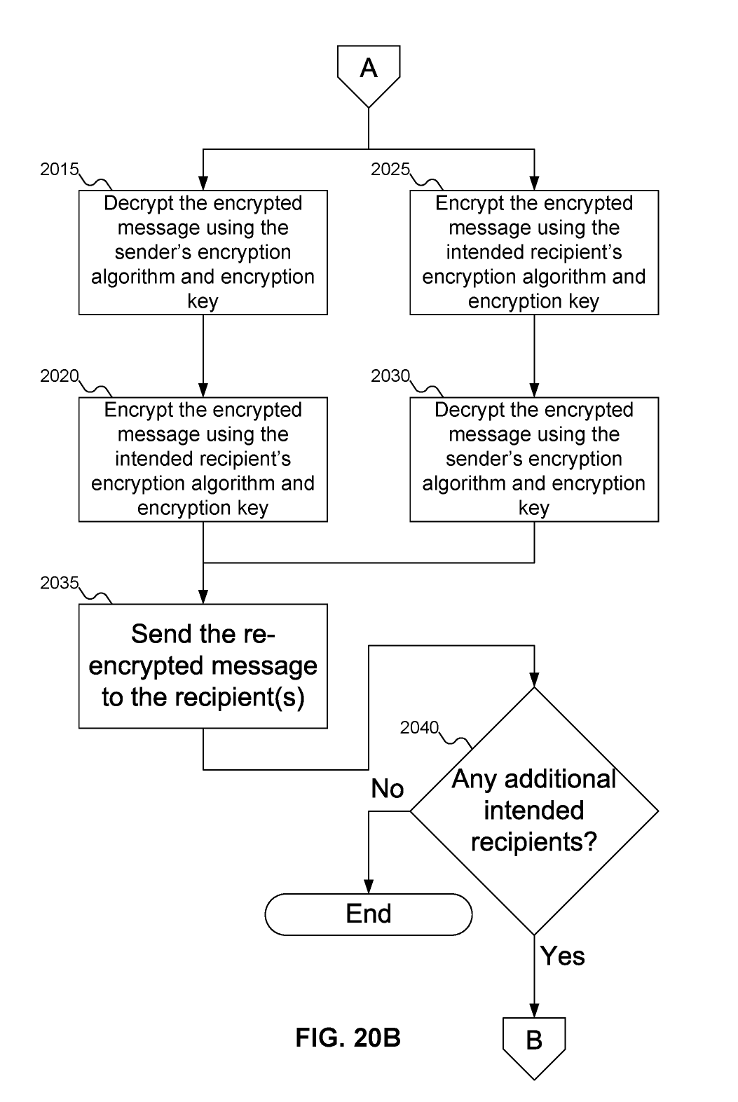

FIGS. 20A-20B show a flowchart of a procedure for the server of FIG. 8 to re-encrypt an encrypted message for each intended recipient, according to an embodiment of the invention. In FIG. 20A, at block 2005, the re-encryption server can identify an intended recipient of the message. At block 2010, the re-encryption server can access an encryption algorithm and encryption key used by the intended recipient. The re-encryption server can select, for example, the intended recipient's preferred encryption algorithm, if one is known, or an encryption algorithm that is at least as secure as the intended recipient's desired level of security.

In FIG. 20B, the re-encryption server can perform re-encryption. In some embodiments of the invention, at block 2015 the re-encryption server can decrypt the encrypted message, using the sender's selected encryption algorithm and encryption key, and at block 2020 the re-encryption server can encrypt the intermediary message using the intended recipient's encryption algorithm and encryption key. In other embodiments of the invention, at block 2025 the re-encryption server can encrypt the intermediary message using the intended recipient's encryption algorithm and encryption key, and at block 2030 the re-encryption server can decrypt the intermediary message using the sender's selected encryption algorithm and encryption key. Either way, at block 2035, the re-encryption server can send the re-encrypted message to the intended recipient.

At block 2040, the re-encryption server can check to see if there are any other intended recipients for the encrypted message. If so, then processing returns to block 2005 of FIG. 20A; if not, then processing is complete.

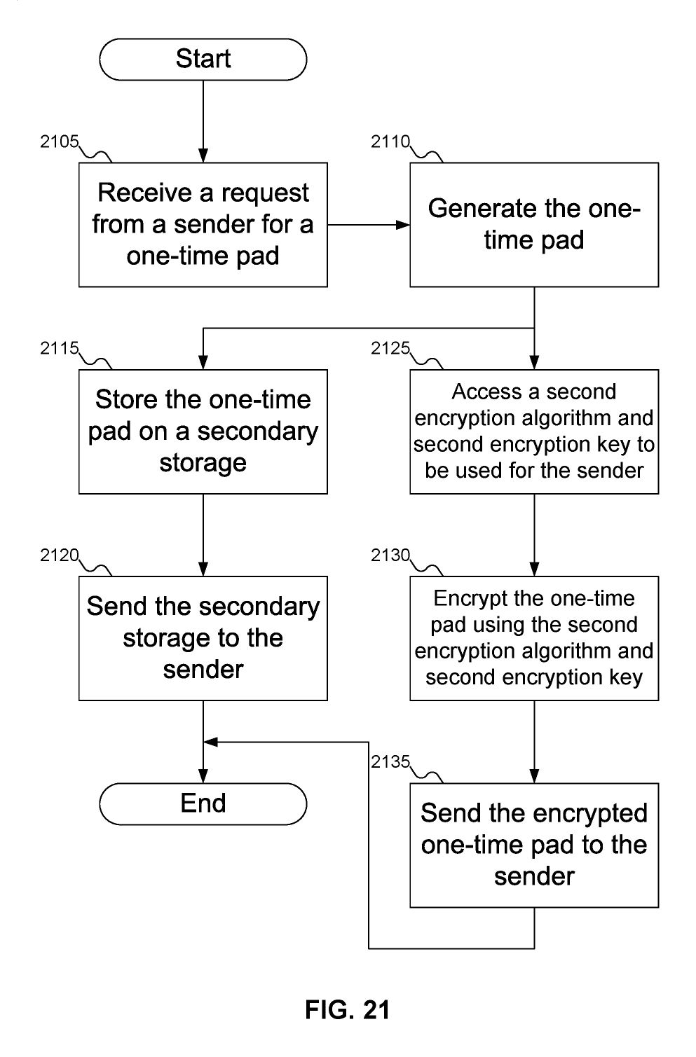

FIG. 21 shows a flowchart of a procedure for the server of FIG. 8 to generate a one-time pad for the computer of FIG. 2 to use to encrypt a message, according to an embodiment of the invention. In FIG. 21, at block 2105, the re-encryption server can receive a request for a one-time pad from the sending computer system. At block 2110, the re-encryption server can generate a one-time pad.

In some embodiments of the invention, at block 2115 the re-encryption server can store the generated one-time pad on secondary storage, such as a CD, DVD, or USB key, and at block 2120 the secondary storage can be sent (via the postal service or a package delivery service) to the sender. The sender can then connect the secondary storage to the storage computer system to use the one-time pad.

In other embodiments of the invention, at block 2125 the re-encryption server can access an encryption algorithm and the sender's encryption key for that encryption algorithm. At block 2130, the re-encryption server can encrypt the one-time pad using the accessed encryption algorithm and encryption key. Finally, at block 2135 the re-encryption server can send the encrypted one-time pad to the sender's computer system.

While FIG. 21 describes how a one-time pad can be sent to a sender, FIG. 21 can easily be adapted to send a one-time pad to a recipient, by replacing all references to “sender” with “recipient”.

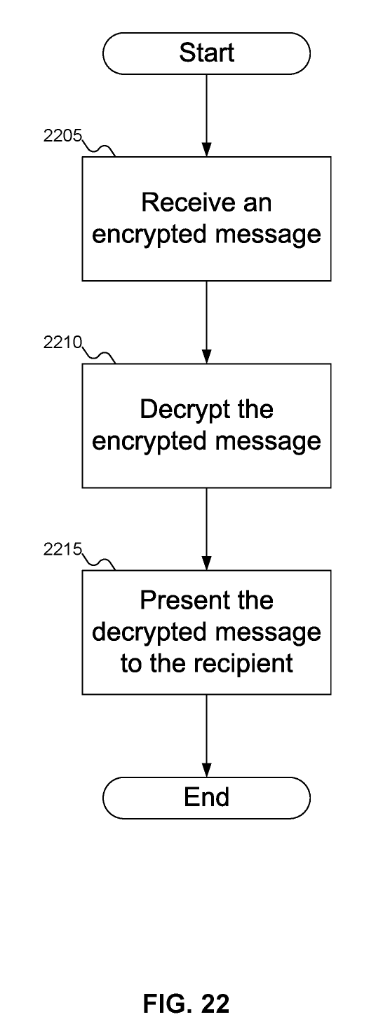

FIG. 22 shows a flowchart of a procedure for the computer of FIG. 13 to decrypt an encrypted message, according to an embodiment of the invention. In FIG. 22, at block 2205, the receiving computer system can receive a re-encrypted message. At block 2210, the receiving computer system can decrypt the message. This can include identifying the encryption algorithm used to encrypt the re-encrypted message (which can be identified by an identifier included with or sent in parallel to the re-encrypted message) and accessing the associated encryption key from storage on the receiving computer system. Finally, at block 2215, the receiving computer system can present the decrypted message to the recipient.

The receiving computer system can also install encryption algorithms and encryption keys, just like blocks 1605-1620 of FIG. 16. As with the sending computer system as described above with reference to FIG. 16, blocks 1605-1620 of FIG. 16, when performed with reference to the receiving computer, can be performed at a different time from blocks 2205-2215 of FIG. 22.

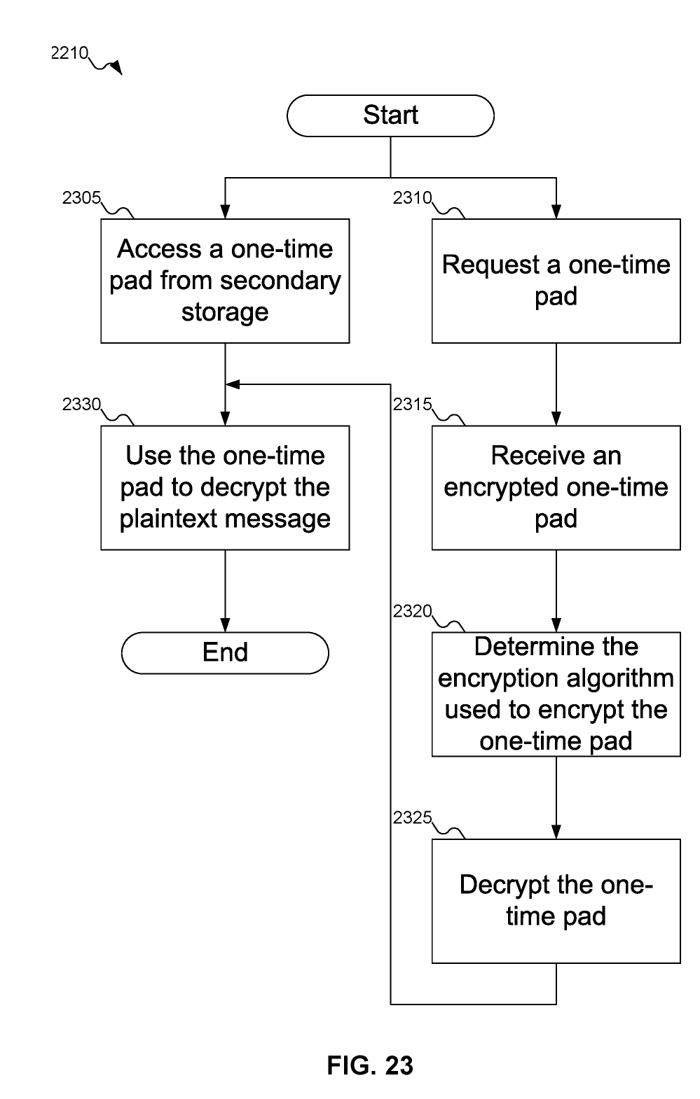

FIG. 23 shows a flowchart of a procedure for the computer of FIG. 13 to use a one-time pad to decrypt an encrypted message, according to an embodiment of the invention. In FIG. 23, at block 2305, the receiving computer system can access a one-time pad from storage (either secondary storage or primary storage). Alternatively, at block 2310, the receiving computer system can request a one-time pad from the re-encryption server. Then, at block 2315, the receiving computer system can receive an encrypted one-time pad from the re-encryption server. At block 2320, the receiving computer system can determine the encryption algorithm used to encrypt the one-time pad (for example, the receiver's preferred encryption algorithm, if one is known, or an encryption algorithm that is at least as secure as the receiver's desired level of security). At block 2325, the receiving computer system can access the encryption key used by the receiving computer system with the determined encryption algorithm and decrypt the one-time pad.

Either way, whether a one-time pad is accessed from storage or received encrypted from the re-encryption server, at block 2330 the receiving computer system can use the one-time pad to encrypt the plaintext message.

In FIGS. 16-23, some embodiments of the invention are shown. But a person skilled in the art will recognize that other embodiments of the invention are also possible, by changing the order of the blocks, by omitting blocks, or by including links not shown in the drawings. All such variations of the flowcharts are considered to be embodiments of the invention, whether expressly described or not.

The following discussion is intended to provide a brief, general description of a suitable machine or machines in which certain aspects of the invention can be implemented. Typically, the machine or machines include a system bus to which is attached processors, memory, e.g., random access memory (RAM), read-only memory (ROM), or other state preserving medium, storage devices, a video interface, and input/output interface ports. The machine or machines can be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines can include embedded controllers, such as programmable or non-programmable logic devices or arrays, Application Specific Integrated Circuits (ASICs), embedded computers, smart cards, and the like. The machine or machines can utilize one or more connections to one or more remote machines, such as through a network interface, modem, or other communicative coupling. Machines can be interconnected by way of a physical and/or logical network, such as an intranet, the Internet, local area networks, wide area networks, etc. One skilled in the art will appreciate that network communication can utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present invention can be described by reference to or in conjunction with associated data including functions, procedures, data structures, application programs, etc. which when accessed by a machine results in the machine performing tasks or defining abstract data types or low-level hardware contexts. Associated data can be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data can be delivered over transmission environments, including the physical and/or logical network, in the form of packets, serial data, parallel data, propagated signals, etc., and can be used in a compressed or encrypted format. Associated data can be used in a distributed environment, and stored locally and/or remotely for machine access.

Embodiments of the invention can include a tangible, non-transitory machine-readable medium comprising instructions executable by one or more processors, the instructions comprising instructions to perform the elements of the inventions as described herein.

Having described and illustrated the principles of the invention with reference to illustrated embodiments, it will be recognized that the illustrated embodiments can be modified in arrangement and detail without departing from such principles, and can be combined in any desired manner. And, although the foregoing discussion has focused on particular embodiments, other configurations are contemplated. In particular, even though expressions such as “according to an embodiment of the invention” or the like are used herein, these phrases are meant to generally reference embodiment possibilities, and are not intended to limit the invention to particular embodiment configurations. As used herein, these terms can reference the same or different embodiments that are combinable into other embodiments.

The foregoing illustrative embodiments are not to be construed as limiting the invention thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this invention as defined in the claims.

Embodiments of the invention can extend to the following statements, without limitation:

Statement 1. An embodiment of the invention includes an encryption engine, comprising:

an encryption module on a computer to generate an encrypted message from a plaintext message using a first encryption algorithm and a first encryption key, the encryption module supporting at least the first encryption algorithm and a second encryption algorithm, the first encryption algorithm offering a first level of security and the second encryption algorithm offering a second level of security, the plaintext message from a sender and including at least one recipient; and

a sending module on the computer to send the encrypted message destined for the at least one recipient,

wherein the encryption module can select between the first encryption algorithm and the second encryption algorithm responsive to the first level of security, the second level of security, and a first desired level of security of the sender.

Statement 2. An embodiment of the invention includes an encryption engine according to statement 1, wherein the encryption module can select between the first encryption algorithm and the second encryption algorithm responsive to the first level of security, the second level of security, the first desired level of security of the sender, and a second desired level of security of the at least one recipient.

Statement 3. An embodiment of the invention includes an encryption engine according to statement 2, wherein:

the plaintext message includes a plurality of recipients each with a second desired level of security; and

the encryption module can select between the first encryption algorithm and the second encryption algorithm responsive to the first level of security, the second level of security, the first desired level of security of the sender, and the second desired levels of security of the plurality of recipients.

Statement 4. An embodiment of the invention includes an encryption engine according to statement 2, wherein the encryption module can select one of the first encryption algorithm and the second encryption algorithm by selecting an encryption algorithm with a minimum level of security that satisfies both the first desired level of security and the second desired level of security.

Statement 5. An embodiment of the invention includes an encryption engine according to statement 1, wherein:

the plaintext message includes a plurality of recipients each with a second desired level of security; and

the encryption engine enables sending the encrypted message to each of the plurality of recipients without encrypting the plaintext message for each of the plurality of recipients separately.

Statement 6. An embodiment of the invention includes an encryption engine according to statement 1, wherein the encryption module is operative to receive from the sender a selection of the first encryption algorithm and the second encryption algorithm from a plurality of different encryption algorithms.

Statement 7. An embodiment of the invention includes an encryption engine according to statement 1, wherein the first encryption key is a one-time pad.

Statement 8. An embodiment of the invention includes an encryption engine according to statement 7, wherein the encryption module is operative to access the one-time pad from secondary storage.

Statement 9. An embodiment of the invention includes an encryption engine according to statement 7, further comprising a receiving module to receive the one-time pad after the sender selects the first encryption algorithm and before the sending module sends the encrypted message.

Statement 10. An embodiment of the invention includes an encryption engine according to statement 9, wherein:

the receiving module is operative to receive an encrypted one-time pad, the encrypted one-time pad including the one-time pad encrypted using the second encryption algorithm; and

the encryption module is operative to decrypt the one-time pad from the encrypted one-time pad using the second encryption algorithm and a second encryption key before generating the encrypted message from the plaintext message using the one-time pad.

Statement 11. An embodiment of the invention includes an encryption engine according to statement 1, further comprising a storage for a first encryption key to use with the first encryption algorithm and a second encryption key to use with the second encryption algorithm.

Statement 12. An embodiment of the invention includes a re-encryption engine, comprising:

a receiving module on a server to receive an encrypted message from a sender, the encrypted message representing a plaintext message encrypted using a first encryption algorithm, the encrypted message destined for at least one recipient;

a re-encryption module on the server to generate a re-encrypted message from the encrypted message, the re-encrypted message generated by decrypting using the first encryption algorithm and a first encryption key and encrypting using a second encryption algorithm and a second encryption key; and

a sending module on the server to transmit the re-encrypted message to the at least one recipient.

Statement 13. An embodiment of the invention includes a re-encryption engine according to statement 12, further comprising an association database storing a plurality of associations, the plurality of associations including a first association between a first identifier of the sender, a second identifier of the first encryption algorithm, and the first encryption key and a second association between a third identifier of the at least one recipient, a fourth identifier of the second encryption algorithm, and the second encryption key.

Statement 14. An embodiment of the invention includes a re-encryption engine according to statement 13, wherein the re-encryption engine is operative to access the first encryption key using the association database, the first identifier of the sender, and the second identifier of the first encryption algorithm, and to access the second encryption algorithm and the second encryption key using the association database and the third identifier of the at least one recipient.

Statement 15. An embodiment of the invention includes a re-encryption engine according to statement 12, further comprising a security level database storing a plurality of associations, the plurality of associations including a first association between a first identifier of the sender and a first desired level of security and a second association between a second identifier of the at least one recipient and a second desired level of security.

Statement 16. An embodiment of the invention includes a re-encryption engine according to statement 15, wherein the sending module is operative to send the second desired level of security to the sender before the encrypted message is encrypted.

Statement 17. An embodiment of the invention includes a re-encryption engine according to statement 12, wherein the second encryption algorithm is the first encryption algorithm.

Statement 18. An embodiment of the invention includes a re-encryption engine according to statement 12, wherein the re-encryption module is operative to generate the re-encrypted message by decrypting the encrypted message using the first encryption algorithm and the first encryption key to produce an intermediary message and then encrypting the intermediary message using the second encryption algorithm and the second encryption key to the encrypted message to produce the re-encrypted message.

Statement 19. An embodiment of the invention includes a re-encryption engine according to statement 12, wherein the re-encryption module is operative to generate the re-encrypted message by encrypting the encrypted message using the second encryption algorithm and the second encryption key to the encrypted message to produce an intermediary message and then decrypting the intermediary message using the first encryption algorithm and the first encryption key to produce the re-encrypted message.

Statement 20. An embodiment of the invention includes a re-encryption engine according to statement 12, wherein the first encryption key is a one-time pad.

Statement 21. An embodiment of the invention includes a re-encryption engine according to statement 20, further comprising a one-time pad generator to generate the one-time pad.

Statement 22. An embodiment of the invention includes a re-encryption engine according to statement 21, wherein the one-time pad generator is operative to generate the one-time pad for storage on a secondary storage for use by the sender.

Statement 23. An embodiment of the invention includes a re-encryption engine according to statement 21, wherein:

the one-time pad generator is operative to generate the one-time pad after the sender requests to encrypt the plaintext message; and

the sending module is operative to send the one-time pad to the sender before the receiving module receives the encrypted message.

Statement 24. An embodiment of the invention includes a re-encryption engine according to statement 23, wherein:

the re-encryption engine further comprises an encryption module to encrypt the one-time pad using a third encryption algorithm and a third encryption key to produce an encrypted one-time pad; and

the sending module is operative to send the encrypted one-time pad to the sender before the receiving module receives the encrypted message.

Statement 25. An embodiment of the invention includes a re-encryption engine according to statement 24, wherein the re-encryption engine is operative to access the third encryption algorithm and the third encryption key from a first association stored in an association database using a first identifier of the sender, the first association associating the first identifier of the sender, a second identifier of the third encryption algorithm, and the third encryption key.

Statement 26. An embodiment of the invention includes a re-encryption engine according to statement 12, wherein:

the receiving module is operative to receive the encrypted message from the sender, the encrypted message destined for a plurality of recipients;

the re-encryption module is operative to generate, for each intended recipient in the plurality of recipients, an intended recipient re-encrypted message from the encrypted message, the intended recipient re-encrypted message generated by decrypting using the first encryption algorithm and a first encryption key and encrypting using an intended recipient encryption algorithm and an intended recipient encryption key for the intended recipient; and

the sending module is operative to transmit, for each intended recipient in the plurality of recipients, the intended recipient re-encrypted message to the intended recipient.

Statement 27. An embodiment of the invention includes a decryption engine, comprising:

a receiving module on a computer to receive an encrypted message, the encrypted message encrypted using a first encryption algorithm;

a decryption module on the computer to generate a decrypted message from the encrypted message using the first encryption algorithm and a first encryption key, the decryption module supporting at least the first encryption algorithm and a second encryption algorithm, the first encryption algorithm offering a first level of security and the second encryption algorithm offering a second level of security; and

a presentation module on the computer to present the decrypted message to a recipient.

Statement 28. An embodiment of the invention includes a decryption engine according to statement 27, wherein the first encryption key is a one-time pad.

Statement 29. An embodiment of the invention includes a decryption engine according to statement 28, wherein the decryption module is operative to access the one-time pad from a secondary storage.

Statement 30. An embodiment of the invention includes a decryption engine according to statement 28, wherein the receiving module is operative to receive the one-time pad contemporaneously with the encrypted message.

Statement 31. An embodiment of the invention includes a decryption engine according to statement 28, wherein:

the receiving module is operative to receive an encrypted one-time pad, the encrypted one-time pad encrypted using the second encryption algorithm; and

the decryption module is operative to decrypt the one-time pad from the encrypted one-time pad using the second encryption algorithm and a second encryption key before generating the decrypted message from the encrypted message using the one-time pad.

Statement 32. An embodiment of the invention includes a system, comprising:

a first computer, including:
an encryption module to generate an encrypted message from a plaintext message using a first encryption algorithm and a first encryption key, the encryption module supporting at least the first encryption algorithm and a second encryption algorithm, the first encryption algorithm offering a first level of security and the second encryption algorithm offering a second level of security, the plaintext message from a sender and including at least one recipient; and
a first sending module to send the encrypted message destined for the at least one recipient;

a server, including:
a first receiving module to receive the encrypted message from the sender;
a re-encryption module to generate a re-encrypted message from the encrypted message, the re-encrypted message generated by decrypting using the first encryption algorithm and the first encryption key and encrypting using a third encryption algorithm and a third encryption key; and
a second sending module to transmit the re-encrypted message to the at least one recipient; and

a second computer, including:
a second receiving module to receive the re-encrypted message;
a decryption module to generate a decrypted message from the encrypted message using the third encryption algorithm and the third encryption key, the decryption module supporting at least the third encryption algorithm and a fourth encryption algorithm, the third encryption algorithm offering a third level of security and the fourth encryption algorithm offering a fourth level of security; and
a presentation module to present the decrypted message to the at least one recipient,

wherein the encryption module can select between the first encryption algorithm and the second encryption algorithm responsive to the first level of security, the second level of security, and a first desired level of security of the sender.

Statement 33. An embodiment of the invention includes a system according to statement 32, wherein the encryption module can select between the first encryption algorithm and the second encryption algorithm responsive to the first level of security, the second level of security, the first desired level of security of the sender, and a second desired level of security of the at least one recipient.

Statement 34. An embodiment of the invention includes a system according to statement 33, wherein:

the plaintext message includes a plurality of recipients each with a second desired level of security; and

the encryption module can select between the first encryption algorithm and the second encryption algorithm responsive to the first level of security, the second level of security, the first desired level of security of the sender, and the second desired levels of security of the plurality of recipients.

Statement 35. An embodiment of the invention includes a system according to statement 33, wherein the encryption module can select one of the first encryption algorithm and the second encryption algorithm by selecting an encryption algorithm with a minimum level of security that satisfies both the first desired level of security and the second desired level of security.

Statement 36. An embodiment of the invention includes a system according to statement 32, wherein:

the plaintext message includes a plurality of recipients each with a second desired level of security; and

the encryption module enables sending the encrypted message to each of the plurality of recipients without encrypting the plaintext message for each of the plurality of recipients separately.

Statement 37. An embodiment of the invention includes a system according to statement 32, wherein the encryption module is operative to receive from the sender a selection of the first encryption algorithm and the second encryption algorithm from a plurality of different encryption algorithms.

Statement 38. An embodiment of the invention includes a system according to statement 32, wherein the first encryption key is a one-time pad.

Statement 39. An embodiment of the invention includes a system according to statement 38, wherein the encryption module is operative to access the one-time pad from secondary storage.

Statement 40. An embodiment of the invention includes a system according to statement 38, the first computer further including a third receiving module to receive the one-time pad after the sender selects the first encryption algorithm and before the first sending module sends the encrypted message.

Statement 41. An embodiment of the invention includes a system according to statement 40, wherein:

the third receiving module is operative to receive an encrypted one-time pad, the encrypted one-time pad including the one-time pad encrypted using the second encryption algorithm; and

the encryption module is operative to decrypt the one-time pad from the encrypted one-time pad using the second encryption algorithm and a second encryption key before generating the encrypted message from the plaintext message using the one-time pad.

Statement 42. An embodiment of the invention includes a system according to statement 38, wherein the server further includes a one-time pad generator to generate the one-time pad.

Statement 43. An embodiment of the invention includes a system according to statement 42, wherein the one-time pad generator is operative to generate the one-time pad for storage on a secondary storage for use by the sender.

Statement 44. An embodiment of the invention includes a system according to statement 42, wherein:

the one-time pad generator is operative to generate the one-time pad after the sender requests to encrypt the plaintext message; and

the second sending module is operative to send the one-time pad to the sender before the first receiving module receives the encrypted message.

Statement 45. An embodiment of the invention includes a system according to statement 44, wherein:

the server further includes a second encryption module to encrypt the one-time pad using the second encryption algorithm and the second encryption key to produce an encrypted one-time pad; and

the second sending module is operative to send the encrypted one-time pad to the sender before the first receiving module receives the encrypted message.

Statement 46. An embodiment of the invention includes a system according to statement 45, wherein the re-encryption module is operative to access the second encryption algorithm and the second encryption key from a first association stored in an association database using a first identifier of the sender, the first association associating the first identifier of the sender, a second identifier of the second encryption algorithm, and the second encryption key.

Statement 47. An embodiment of the invention includes a system according to statement 32, wherein the first computer further includes a storage for a first encryption key to use with the first encryption algorithm and a second encryption key to use with the second encryption algorithm.

Statement 48. An embodiment of the invention includes a system according to statement 32, wherein the server further includes an association database storing a plurality of associations, the plurality of associations including a first association between a first identifier of the sender, a second identifier of the first encryption algorithm, and the first encryption key and a second association between a third identifier of the at least one recipient, a fourth identifier of the third encryption algorithm, and the third encryption key.

Statement 49. An embodiment of the invention includes a system according to statement 48, wherein the re-encryption module is operative to access the first encryption key using the association database, the first identifier of the sender, and the second identifier of the first encryption algorithm, and to access the third encryption algorithm and the third encryption key using the association database and the third identifier of the at least one recipient.

Statement 50. An embodiment of the invention includes a system according to statement 32, wherein the server further includes a security level database storing a plurality of associations, the plurality of associations including a first association between a first identifier of the sender and a first desired level of security and a second association between a second identifier of the at least one recipient and a second desired level of security.

Statement 51. An embodiment of the invention includes a system according to statement 50, wherein the second sending module is operative to send the second desired level of security to the sender before the encrypted message is encrypted.

Statement 52. An embodiment of the invention includes a system according to statement 32, wherein the third encryption algorithm is the first encryption algorithm.

Statement 53. An embodiment of the invention includes a system according to statement 32, wherein the re-encryption module is operative to generate the re-encrypted message by decrypting the encrypted message using the first encryption algorithm and the first encryption key to produce an intermediary message and then encrypting the intermediary message using the third encryption algorithm and the third encryption key to the encrypted message to produce the re-encrypted message.

Statement 54. An embodiment of the invention includes a system according to statement 32, wherein the re-encryption module is operative to generate the re-encrypted message by encrypting the encrypted message using the third encryption algorithm and the third encryption key to the encrypted message to produce an intermediary message and then decrypting the intermediary message using the first encryption algorithm and the first encryption key to produce the re-encrypted message.

Statement 55. An embodiment of the invention includes a system according to statement 32, wherein:

the first receiving module is operative to receive the encrypted message from the sender, the encrypted message destined for a plurality of recipients;

the re-encryption module is operative to generate, for each intended recipient in the plurality of recipients, an intended recipient re-encrypted message from the encrypted message, the intended recipient re-encrypted message generated by decrypting using the first encryption algorithm and a first encryption key and encrypting using an intended recipient encryption algorithm and an intended recipient encryption key; and

the second sending module is operative to transmit, for each intended recipient in the plurality of recipients, the intended recipient re-encrypted message to the intended recipient.

Statement 56. An embodiment of the invention includes a system according to statement 32, wherein the third encryption key is a one-time pad.

Statement 57. An embodiment of the invention includes a system according to statement 56, wherein the decryption module is operative to access the one-time pad from a secondary storage.

Statement 58. An embodiment of the invention includes a system according to statement 56, wherein the second receiving module is operative to receive the one-time pad contemporaneously with the encrypted message.

Statement 59. An embodiment of the invention includes a system according to statement 56, wherein:

the second receiving module is operative to receive an encrypted one-time pad, the encrypted one-time pad including the one-time pad encrypted using the fourth encryption algorithm; and

the decryption module is operative to decrypt the one-time pad from the encrypted one-time pad using the fourth encryption algorithm and a fourth encryption key before generating the decrypted message from the encrypted message using the one-time pad.

Statement 60. An embodiment of the invention includes a method, comprising:

receiving on a computer a request from a sender to send a plaintext message to at least one recipient;

selecting on the computer a first encryption algorithm from at least the first encryption algorithm and a second encryption algorithm, the first encryption algorithm offering a first level of security and the second encryption algorithm offering a second level of security, wherein the first encryption algorithm is selected responsive to the first level of security, the second level of security, and a first desired level of security of the sender;

encrypting on the computer the plaintext message using the first encryption algorithm and a first encryption key to produce an encrypted message; and

sending the encrypted message from the computer destined for the at least one recipient.

Statement 61. An embodiment of the invention includes a method according to statement 60, wherein receiving a request to send a plaintext message includes intercepting the request to send the plaintext message, the request to send the plaintext message sent to an electronic mail system.

Statement 62. An embodiment of the invention includes a method according to statement 60, wherein selecting a first encryption algorithm includes selecting the first encryption algorithm responsive to the first level of security, the second level of security, a first desired level of security of the sender, and a second desired level of security of the at least one recipient.

Statement 63. An embodiment of the invention includes a method according to statement 62, wherein selecting a first encryption algorithm includes selecting the first encryption algorithm responsive to the first level of security, the second level of security, a first desired level of security of the sender, and a plurality of second desired levels of security of a plurality of recipients.

Statement 64. An embodiment of the invention includes a method according to statement 62, wherein selecting a first encryption algorithm includes selecting the first encryption algorithm if the first level of security satisfies both the first desired level of security and the second desired level of security.

Statement 65. An embodiment of the invention includes a method according to statement 60, wherein sending the encrypted message destined for the at least one recipient includes sending the encrypted message to a plurality of recipients without encrypting the plaintext message for each of a plurality of recipients separately.

Statement 66. An embodiment of the invention includes a method according to statement 60, wherein selecting a first encryption algorithm includes receiving from the sender a selection of the first encryption algorithm and the second encryption algorithm from a plurality of different encryption algorithms.

Statement 67. An embodiment of the invention includes a method according to statement 60, wherein encrypting the plaintext message using the first encryption algorithm includes encrypting the plaintext message using a one-time pad as the first encryption key.

Statement 68. An embodiment of the invention includes a method according to statement 67, wherein encrypting the plaintext message using the first encryption algorithm further includes accessing the one-time pad from a secondary storage.

Statement 69. An embodiment of the invention includes a method according to statement 67, wherein encrypting the plaintext message using the first encryption algorithm further includes receiving the one-time pad after the sender requests to send the plaintext message and before the encrypted message is sent.

Statement 70. An embodiment of the invention includes a method according to statement 69, wherein receiving the one-time pad includes:

receiving an encrypted one-time pad, the encrypted one-time pad encrypted using the second encryption algorithm; and

decrypting the encrypted one-time pad using the second encryption algorithm and a second encryption key.

Statement 71. An embodiment of the invention includes a method, comprising:

receiving on a server an encrypted message from a sender, the encrypted message representing a plaintext message encrypted using a first encryption algorithm, the encrypted message destined for at least one recipient;

re-encrypting on the server the encrypted message to produce a re-encrypted message using a re-encryption module, the re-encrypted message produced by decrypting using the first encryption algorithm and a first encryption key and encrypting using a second encryption algorithm and a second encryption key; and

sending from the server the re-encrypted message to at least the recipient.

Statement 72. An embodiment of the invention includes a method according to statement 71, further comprising:

accessing the first encryption key from a first association stored in an association database using a first identifier of the sender and a second identifier of the first encryption algorithm, the first association associating the first identifier of the sender, the second identifier of the first encryption algorithm, and the first encryption key; and

accessing the second encryption algorithm and the second encryption key from a second association stored in the association database, the second association associating a third identifier of the at least one recipient, a fourth identifier of the second encryption algorithm, and the second encryption key.

Statement 73. An embodiment of the invention includes a method according to statement 71, further comprising:

accessing a desired level of security for the at least one recipient from a security level database; and

sending the desired level of security for the at least one recipient to the sender before receiving the encrypted message.

Statement 74. An embodiment of the invention includes a method according to statement 71, wherein re-encrypting the encrypted message to produce a re-encrypted message includes re-encrypting the encrypted message to produce the re-encrypted message using the re-encryption module, the re-encrypted message produced by decrypting using the first encryption algorithm and a first encryption key and encrypting using the first encryption algorithm and the second encryption key.

Statement 75. An embodiment of the invention includes a method according to statement 71, wherein re-encrypting the encrypted message to produce a re-encrypted message using a re-encryption module includes:

decrypting the encrypted message using the first encryption algorithm and the first encryption key to produce an intermediary message; and

encrypting the intermediary message using the second encryption algorithm and the second encryption key to produce the re-encrypted message.

Statement 76. An embodiment of the invention includes a method according to statement 71, wherein re-encrypting the encrypted message to produce a re-encrypted message using a re-encryption module includes:

encrypting the encrypted message using the second encryption algorithm and the second encryption key to produce an intermediary message.

decrypting the intermediary message using the first encryption algorithm and the first encryption key to produce the re-encrypted message.

Statement 77. An embodiment of the invention includes a method according to statement 71, wherein receiving an encrypted message from a sender includes receiving the encrypted message from the sender, the encrypted message representing a plaintext message encrypted using a first encryption algorithm and a one-time pad.

Statement 78. An embodiment of the invention includes a method according to statement 77, further comprising generating the one-time pad.

Statement 79. An embodiment of the invention includes a method according to statement 78, further comprising:

storing the one-time pad on a physical secondary storage; and

sending the physical secondary storage to the sender before receiving the encrypted message from the sender.

Statement 80. An embodiment of the invention includes a method according to statement 78, further comprising:

receiving a request from the sender for a one-time pad; and

sending the one-time pad to the sender before the sender encrypts the plaintext message.

Statement 81. An embodiment of the invention includes a method according to statement 80, wherein sending the one-time pad to the sender includes:

accessing a third encryption algorithm and a third encryption key;

encrypting the one-time pad using the third encryption algorithm and the third encryption key to produce an encrypted one-time pad; and

sending the encrypted one-time pad to the sender.

Statement 82. An embodiment of the invention includes a method according to statement 81, wherein accessing the third encryption algorithm and the third encryption key includes accessing the third encryption algorithm and the third encryption key from a first association stored in an association database using a first identifier of the sender, the first association associating the first identifier of the sender, the second identifier of the third encryption algorithm, and the third encryption key.

Statement 83. An embodiment of the invention includes a method according to statement 81, wherein sending the encrypted one-time pad to the sender includes sending the encrypted one-time pad to the sender before the sender encrypts the plaintext message to produce the encrypted message.

Statement 84. An embodiment of the invention includes a method according to statement 71, wherein:

receiving an encrypted message from a sender includes receiving the encrypted message from the sender, the encrypted message destined for a plurality of recipients;

re-encrypting the encrypted message to produce a re-encrypted message using a re-encryption module includes, for each intended recipient in the plurality of recipients, re-encrypting the encrypted message to produce an intended recipient re-encrypted message by decrypting using the first encryption algorithm and a first encryption key and encrypting using an intended recipient encryption algorithm and an intended recipient encryption key; and

sending the re-encrypted message to at least the recipient includes, for each intended recipient in the plurality of recipients, sending the intended recipient re-encrypted message to the intended recipient.

Statement 85. An embodiment of the invention includes a method, comprising:

receiving on a computer an encrypted message, the encrypted message representing a plaintext message encrypted using a first encryption algorithm;

decrypting the encrypted message with a decryption module using the first encryption algorithm and a first encryption key to produce the plaintext message, the decryption module supporting at least the first encryption algorithm and a second encryption algorithm, the first encryption algorithm offering a first level of security and the second encryption algorithm offering a second level of security; and

presenting the plaintext message to a recipient on the computer.

Statement 86. An embodiment of the invention includes a method according to statement 85, wherein decrypting the encrypted message with a decryption module using the first encryption algorithm and a first encryption key includes decrypting the encrypted message with the decryption module using a one-time pad to produce the plaintext message.

Statement 87. An embodiment of the invention includes a method according to statement 86, wherein decrypting the encrypted message with the decryption module using a one-time pad includes accessing the one-time pad from a secondary storage.

Statement 88. An embodiment of the invention includes a method according to statement 86, wherein decrypting the encrypted message with the decryption module using a one-time pad includes receiving the one-time pad contemporaneously with the encrypted message.

Statement 89. An embodiment of the invention includes a method according to statement 88, wherein receiving the one-time pad contemporaneously with the encrypted message includes:

receiving an encrypted one-time pad, the encrypted one-time pad encrypted using a the second encryption algorithm; and

decrypting the encrypted one-time pad using the second encryption algorithm and a second encryption key to produce the one-time pad.

Statement 90. An embodiment of the invention includes a method according to statement 88, wherein receiving the one-time pad contemporaneously with the encrypted message includes receiving the one-time pad before decrypting the encrypted message to produce the plaintext message.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

What is claimed is:

1. A re-encryption engine, comprising:
a receiving module on a server to receive an encrypted message from a sender, the encrypted message representing a plaintext message encrypted using a first encryption algorithm, the encrypted message destined for at least one recipient;
a re-encryption module on the server to generate a re-encrypted message from the encrypted message, the re-encrypted message generated by decrypting using the first encryption algorithm and a first encryption key and encrypting using a second encryption algorithm and a second encryption key; and
a sending module on the server to transmit the re-encrypted message to the at least one recipient.

2. A re-encryption engine according to claim 1, further comprising an association database storing a plurality of associations, the plurality of associations including a first association between a first identifier of the sender, a second identifier of the first encryption algorithm, and the first encryption key and a second association between a third identifier of the at least one recipient, a fourth identifier of the second encryption algorithm, and the second encryption key.

3. A re-encryption engine according to claim 1, further comprising a security level database storing a plurality of associations, the plurality of associations including a first association between a first identifier of the sender and a first desired level of security and a second association between a second identifier of the at least one recipient and a second desired level of security.

4. A re-encryption engine according to claim 1, wherein the re-encryption module is operative to generate the re-encrypted message by decrypting the encrypted message using the first encryption algorithm and the first encryption key to produce an intermediary message and then encrypting the intermediary message using the second encryption algorithm and the second encryption key to the encrypted message to produce the re-encrypted message.

5. A re-encryption engine according to claim 1, wherein the re-encryption module is operative to generate the re-encrypted message by encrypting the encrypted message using the second encryption algorithm and the second encryption key to the encrypted message to produce an intermediary message and then decrypting the intermediary message using the first encryption algorithm and the first encryption key to produce the re-encrypted message.

6. A re-encryption engine according to claim 1, wherein the first encryption key is a one-time pad.

7. A re-encryption engine according to claim 6, further comprising a one-time pad generator to generate the one-time pad.

8. An encryption engine, comprising:
an encryption module on a computer to generate an encrypted message from a plaintext message using a first encryption algorithm and a first encryption key, the encryption module supporting at least the first encryption algorithm and a second encryption algorithm, the first encryption algorithm offering a first level of security and the second encryption algorithm offering a second level of security, the plaintext message from a sender and including at least one recipient; and
a sending module on the computer to send the encrypted message destined for the at least one recipient,
wherein the encryption module can select between the first encryption algorithm and the second encryption algorithm responsive to the first level of security, the second level of security, and a first desired level of security of the sender.

9. An encryption engine according to claim 8, wherein the encryption module is operative to receive from the sender a selection of the first encryption algorithm and the second encryption algorithm from a plurality of different encryption algorithms.

10. An encryption engine according to claim 8, wherein the first encryption key is a one-time pad.

11. An encryption engine according to claim 8, further comprising a storage for a first encryption key to use with the first encryption algorithm and a second encryption key to use with the second encryption algorithm.

12. A method, comprising:
receiving on a server an encrypted message from a sender, the encrypted message representing a plaintext message encrypted using a first encryption algorithm, the encrypted message destined for at least one recipient;
re-encrypting on the server the encrypted message to produce a re-encrypted message using a re-encryption module, the re-encrypted message produced by decrypting using the first encryption algorithm and a first encryption key and encrypting using a second encryption algorithm and a second encryption key; and
sending from the server the re-encrypted message to at least the recipient.

13. A method according to claim 12, further comprising:
accessing a desired level of security for the at least one recipient from a security level database; and
sending the desired level of security for the at least one recipient to the sender before receiving the encrypted message.

14. A method according to claim 12, wherein re-encrypting the encrypted message to produce a re-encrypted message using a re-encryption module includes:
decrypting the encrypted message using the first encryption algorithm and the first encryption key to produce an intermediary message; and
encrypting the intermediary message using the second encryption algorithm and the second encryption key to produce the re-encrypted message.

15. A method according to claim 12, wherein re-encrypting the encrypted message to produce a re-encrypted message using a re-encryption module includes:
encrypting the encrypted message using the second encryption algorithm and the second encryption key to produce an intermediary message.
decrypting the intermediary message using the first encryption algorithm and the first encryption key to produce the re-encrypted message.

16. A method according to claim 12, wherein receiving an encrypted message from a sender includes receiving the encrypted message from the sender, the encrypted message representing a plaintext message encrypted using a first encryption algorithm and a one-time pad.

17. A method according to claim 16, further comprising generating the one-time pad.

18. A method according to claim 17, further comprising:
receiving a request from the sender for a one-time pad; and
sending the one-time pad to the sender before the sender encrypts the plaintext message.

19. A method according to claim 18, wherein sending the one-time pad to the sender includes:
accessing a third encryption algorithm and a third encryption key;
encrypting the one-time pad using the third encryption algorithm and the third encryption key to produce an encrypted one-time pad; and
sending the encrypted one-time pad to the sender.

20. A method according to claim 12, wherein:
receiving an encrypted message from a sender includes receiving the encrypted message from the sender, the encrypted message destined for a plurality of recipients;
re-encrypting the encrypted message to produce a re-encrypted message using a re-encryption module includes, for each intended recipient in the plurality of recipients, re-encrypting the encrypted message to produce an intended recipient re-encrypted message by decrypting using the first encryption algorithm and a first encryption key and encrypting using an intended recipient encryption algorithm and an intended recipient encryption key; and
sending the re-encrypted message to at least the recipient includes, for each intended recipient in the plurality of recipients, sending the intended recipient re-encrypted message to the intended recipient.
